(19) United States
(12) Patent Application Publication
(10) Pub. No.: US 2023/0297068 A1
(43) Pub. Date: Sep. 21, 2023

(54) INFORMATION PROCESSING DEVICE AND INFORMATION PROCESSING METHOD

(71) Applicant: FANUC CORPORATION, Minamitsuru-gun, Yamanashi (JP)

(72) Inventor: Weijia LI, Yamanashi (JP)

(21) Appl. No.: 18/014,372

(22) PCT Filed: Jul. 20, 2021
(86) PCT No.: PCT/JP2021/027151

§ 371 Date: Jan. 4, 2023

(30) Foreign Application Priority Data
Jul. 27, 2020 (JP) 2020-126620

(51) Int. Cl. G05B 19/4097

(52) U.S. Cl. CPC G05B 19/4097; G05B 2219/35134; G05B 2219/45063

(57) ABSTRACT

The present invention easily generates training data needed for generating a training model for identifying a position for retrieving a bulk-loaded work piece. An information processing device, according to the present invention, for processing information for retrieving a work piece using a hand, said device comprising: a reception unit that receives retrieval conditions including information about the hand or the work piece; a pre-processing unit that at least derives the position of the center of gravity of the work piece on the basis of a 3D CAD model of the work piece; and a first processing unit that, on the basis of the derived position of the center of gravity of the work piece, derives sectional features of the 3D CAD model of the work piece according to the retrieval conditions.

### TECHNICAL FIELD

The present invention relates to an information processing device and an information processing method.

### BACKGROUND ART

For detecting a pick-up position of an object (hereinafter also referred to as a “workpiece”), teaching has been performed using a workpiece distance image measured by a three-dimensional measuring machine. As a technique of performing teaching by means of the distance image, a technique by computer-aided design (CAD) matching or a technique of conducting a search based on a setting parameter has been generally used, for example. The distance image described herein means an image obtained by measurement of a surface of a measurement target (the workpiece) and having information on a depth from the three-dimensional measuring machine at each pixel of a captured image. That is, each pixel of the distance image can be taken as one having three-dimensional coordinate information in a three-dimensional coordinate system of the three-dimensional measuring machine.

On this point, the following technique has been known: object distance images from a plurality of angles are captured, a three-dimensional model of an object is generated based on the plurality of captured distance images, extraction images indicating particular portions of the object that correspond to the plurality of angles are generated based on the generated three-dimensional model, and machine learning is performed using, as teacher data, the plurality of distance images and the extraction images respectively corresponding to the plurality of distance images; and in this manner, the model for specifying a position at which a robot grips the object is generated. For example, see Patent Document 1.

Patent Document 1: Japanese Unexamined Patent Application, Publication No. 2019-56966

### DISCLOSURE OF THE INVENTION

### Problems to Be Solved by the Invention

However, for generating the model for specifying the pick-up position of the workpiece, the distance images of the object need to be captured from the plurality of angles, and it takes time and effort.

In a case where a plurality of workpieces is loaded in bulk, it is necessary for specifying the pick-up positions of the workpieces loaded in bulk to consider the position and posture of a hand upon holding of a target workpiece such that there is no interference between the hand and a surrounding obstacle such as a workpiece or a container wall upon holding of the workpiece at the pick-up position.

For this reason, there has been a demand for easy generation of training data (also referred to as “training data”) necessary for generation of a trained model for specifying the pick-up positions of the workpieces loaded in bulk.

### Means for Solving the Problems

(1) One aspect of an information processing device of the present disclosure is an information processing device for processing information for picking up a workpiece by means of a hand, the information processing device including a receiving unit configured to receive a pick-up condition including information on the hand or the workpiece, a preprocessing unit configured to derive at least the position of the center of gravity of the workpiece based on a 3D CAD model of the workpiece, and a first processing unit configured to derive a local feature of the 3D CAD model of the workpiece according to the pick-up condition based on the derived position of the center of gravity of the workpiece.

(2) One aspect of an information processing method of the present disclosure is an information processing method for implementation by a computer for processing information for picking up a workpiece by means of a hand, the information processing method including a receiving step of receiving a pick-up condition including information on the hand or the workpiece, a preprocessing step of deriving at least the position of the center of gravity of the workpiece based on a 3D CAD model of the workpiece, and a first processing step of deriving a local feature of the 3D CAD model of the workpiece according to the pick-up condition based on the derived position of the center of gravity of the workpiece.

### Effects of the Invention

According to one aspect, the training data (“teacher data”) necessary for generation of the trained model for specifying the pick-up positions of the workpieces loaded in bulk can be easily generated.

### BRIEF DESCRIPTION OF THE DRAWINGS

FIG. 1 is a view showing one example of a configuration of a robot system according to a first embodiment;

FIG. 2 is a functional block diagram showing a functional configuration example of an information processing device according to the first embodiment;

FIG. 3 is a view showing one example of a workpiece;

FIG. 4 is a view showing one example of the workpiece;

FIG. 5 is a view showing one example of a drawing on a virtual space;

FIG. 6A is a view showing one example of a 2D CAD diagram obtained by projection of CAD data on a randomly-generated overlapping state of a plurality of workpieces;

FIG. 6B is a view showing one example of a 2D CAD diagram obtained by projection of 3D CAD data with pick-up position candidate data calculated by a first pick-up candidate calculation unit;

FIG. 6C is a view showing one example of a 2D CAD diagram obtained by projection of 3D CAD data with a cylindrical virtual hand drawn at each pick-up position candidate;

FIG. 6D is a view showing one example of a 2D CAD diagram obtained by projection of 3D CAD data with pick-up position candidate data after candidates for which interference had been detected has been deleted;

FIG. 7 is a flowchart for describing training data generation processing of the information processing device;

FIG. 8 is a functional block diagram showing a functional configuration example of an information processing device according to a second embodiment;

FIG. 9 is a flowchart for describing training data generation processing of the information processing device;

FIG. 10 is a view showing one example of a configuration of a robot system according to a third embodiment;

FIG. 11 is a functional block diagram showing a functional configuration example of an information processing device according to the third embodiment;

FIG. 12 is a view showing one example for describing preprocessing for three-dimensional point cloud data; and

FIG. 13 is a flowchart for describing training data generation processing of the information processing device.

### PREFERRED MODE FOR CARRYING OUT THE INVENTION

First to third embodiments will be described in detail with reference to the drawings.

These embodiments are common to each other in a configuration in which training data (“teacher data”) necessary for generation of a trained model for specifying pick-up positions of workpieces randomly loaded in bulk and overlapping with each other is easily generated.

Note that in the first embodiment, in training data (“teacher data”, “training data”) generation processing, a state in which the workpieces are loaded in bulk and overlap with each other is randomly generated on a virtual space by means of 3D CAD data on the workpieces, and targeting for a plurality of two-dimensional projection images obtained by projection of the randomly-generated overlapping state of the plurality of workpieces, the training data is generated with label data which is a plurality of two-dimensional projection images with pick-up position candidate data generated on each of the overlapping workpieces in each piece of 3D CAD data. On the other hand, the second embodiment is different from the first embodiment in that targeting for a plurality of two-dimensional images, which is acquired by an imaging device, of workpieces loaded in bulk and overlapping with each other, the training data is generated with label data which is a plurality of two-dimensional images with pick-up position candidate data calculated on the workpieces based on a feature on each of the plurality of two-dimensional images and a feature of a 3D CAD model of the workpiece. The third embodiment is different from the first embodiment and the second embodiment in that targeting for plural pieces of three-dimensional point cloud data acquired on workpieces loaded in bulk and overlapping with each other by, e.g., a three-dimensional measuring machine, the training data is generated with label data which is plural pieces of three-dimensional point cloud data with pick-up position candidate data calculated on the workpieces based on each of the plural pieces of three-dimensional point cloud data and 3D CAD data on the workpieces.

Hereinafter, the first embodiment will be first described in detail, and then, differences of the second and third embodiments from the first embodiment will be particularly described.

### First Embodiment

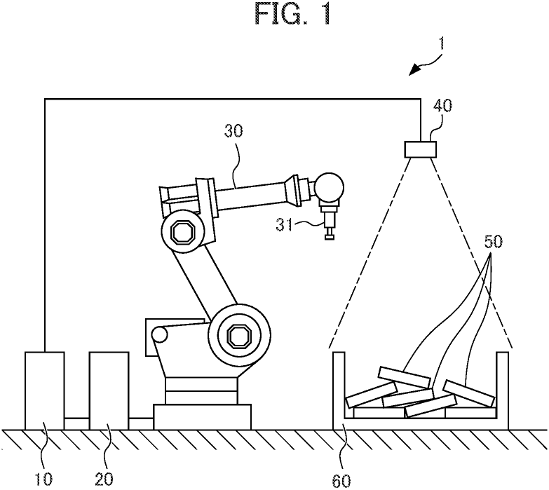

FIG. 1 is a view showing one example of a configuration of a robot system 1 according to the first embodiment.

As shown in FIG. 1, the robot system 1 has an information processing device 10, a robot control device 20, a robot 30, an imaging device 40, a plurality of workpieces 50, and a container 60.

The information processing device 10, the robot control device 20, the robot 30, and the imaging device 40 may be directly connected to each other via a not-shown connection interface. Note that the information processing device 10, the robot control device 20, the robot 30, and the imaging device 40 may be connected to each other via a not-shown network such as a local area network (LAN) or the Internet. In this case, the information processing device 10, the robot control device 20, the robot 30, and the imaging device 40 include not-shown communication units for communication thereamong via such connection. For the sake of simplicity in description, FIG. 1 shows the information processing device 10 and the robot control device 20 independently of each other, and the information processing device 10 in this case may include a computer, for example. The present disclosure is not limited to such a configuration, and for example, the information processing device 10 may be mounted inside the robot control device 20 and be integrated with the robot control device 20.

The robot control device 20 is a device well-known by those skilled in the art for controlling operation of the robot 30. For example, the robot control device 20 receives, from the information processing device 10, pick-up position information on a workpiece 50 selected by the later-described information processing device 10 among the workpieces 50 loaded in bulk. The robot control device 20 generates a control signal for controlling operation of the robot 30 such that the workpiece 50 at a pick-up position received from the information processing device 10 is picked up. Then, the robot control device 20 outputs the generated control signal to the robot 30.

Note that the robot control device 20 may include the information processing device 10 as described later.

The robot 30 is a robot to be operated based on control by the robot control device 20. The robot 30 includes a base portion rotatable about an axis in the vertical direction, a movable and rotatable arm, and a pick-up hand 31 attached to the arm to hold the workpiece 50. Note that in FIG. 1, an air suction pick-up hand is attached as the pick-up hand 31 of the robot 30, but a gripping pick-up hand may be attached or a magnetic hand picking up an iron workpiece by magnetic force may be attached.

In response to the control signal output from the robot control device 20, the robot 30 drives the arm and the pick-up hand 31, moves the pick-up hand 31 to the pick-up position selected by the information processing device 10, and holds and picks up one of the workpieces 50 loaded in bulk from the container 60.

Note that a transfer destination of the picked-up workpiece 50 is not shown in the figure. A specific configuration of the robot 30 has been well-known by those skilled in the art, and therefore, detailed description thereof will be omitted.

Note that for the information processing device 10 and the robot control device 20, a machine coordinate system for controlling the robot 30 and a camera coordinate system indicating the pick-up position of the workpiece 50 are associated with each other by calibration performed in advance.

The imaging device 40 is, for example, a digital camera, and acquires a two-dimensional image in such a manner that the workpieces 50 loaded in bulk in the container 60 are projected onto a plane perpendicular to the optical axis of the imaging device 40.

Note that the imaging device 40 may be a three-dimensional measuring machine such as a stereo camera, as described later.

The workpieces 50 are, in the container 60, placed in a disorderly manner including a state in which the workpieces 50 are loaded in bulk. The workpiece 50 may only be required to be holdable by the pick-up hand 31 attached to the arm of the robot 30, and the shape, etc. thereof are not particularly limited.

### <Information Processing Device 10>

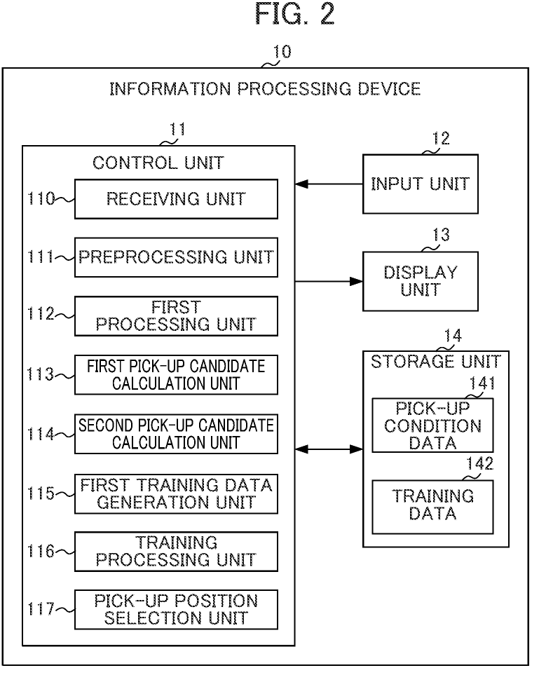

FIG. 2 is a functional block diagram showing a functional configuration example of the information processing device 10 according to the first embodiment.

The information processing device 10 is a computer device well-known by those skilled in the art, and as shown in FIG. 2, has a control unit 11, an input unit 12, a display unit 13, and a storage unit 14. The control unit 11 has a receiving unit 110, a preprocessing unit 111, a first processing unit 112, a first pick-up candidate calculation unit 113, a second pick-up candidate calculation unit 114, a first training data generation unit 115, a training processing unit 116, and a pick-up position selection unit 117.

### <Input Unit 12>

The input unit 12 is, for example, a keyboard or a touch panel arranged on the later-described display unit 13, and receives input from a user. Specifically, as described later, the user inputs, via the input unit 12, a pick-up condition including information on the type of pick-up hand 31, the shape and size of a portion contacting the workpiece 50, etc., for example.

### <Display Unit 13>

The display unit 13 is, for example, a liquid crystal display, and displays a numerical value and a graph of the pick-up condition received by the later-described receiving unit 110 via the input unit 12, 3D CAD data on the workpieces 50 from the later-described preprocessing unit 111, etc.

### <Storage Unit 14>

The storage unit 14 is, for example, a ROM or a HDD, and may store pick-up condition data 141 and training data 142 together with various control programs.

The pick-up condition data 141 includes, as described above, the pick-up condition received from the user by the later-described receiving unit 110 via the input unit 12, the pick-up condition including at least one of information on the shape of the portion of the pick-up hand 31 contacting the workpiece 50, information on a contact normal direction of the portion, information on a contact area of the portion, information on a movable range of the pick-up hand 31, information on the surface curvature of the workpiece 50, information on material and friction coefficient distribution of the workpiece 50, or part of pick-up availability information.

The training data 142 includes training data (“teacher data”), as label data, including a plurality of two-dimensional projection images with specified pick-up position candidates, targeting a plurality of two-dimensional projection images of the plurality of workpieces 50, which is randomly loaded in bulk and overlap with each other, on a virtual space generated by the later-described first training data generation unit 115.

### <Control Unit 11>

The control unit 11 is one well-known by those skilled in the art and having a central processing unit (CPU), a ROM, a random access memory (RAM), a complementary metal-oxide-semiconductor (CMOS) memory, etc., and these components are communicable with each other via a bus.

The CPU is a processor that controls the information processing device 10 in an integrated manner. The CPU reads a system program and an application program stored in the ROM via the bus, thereby controlling the entirety of the information processing device 10 according to the system program and the application program. In this manner, the control unit 11 implements, as shown in FIG. 2, the functions of the receiving unit 110, the preprocessing unit 111, the first processing unit 112, the first pick-up candidate calculation unit 113, the second pick-up candidate calculation unit 114, the first training data generation unit 115, the training processing unit 116, and the pick-up position selection unit 117. The RAM stores various types of data such as temporary calculation and display data. The CMOS memory is backed up by a not-shown battery, and functions as a nonvolatile memory that holds a storage state thereof even when the information processing device 10 is powered off.

### <Receiving Unit 110>

The receiving unit 110 may receive the pick-up condition, which includes the information on the type of pick-up hand 31, the shape and size of the portion contacting the workpiece 50, etc., input by the user via the input unit 12, and may store the pick-up condition in the later-described storage unit 14. That is, the receiving unit 110 may receive information and store such information in the storage unit 14, the information including information on whether the pick-up hand 31 is of the air suction type or the gripping type, information on the shape and size of a suction pad contact portion where the pick-up hand 31 contacts the workpiece 50, information on the number of suction pads, information on the interval and distribution of a plurality of pads in a case where the pick-up hand 31 has the plurality of suction pads, and information on the shape and size of a portion where a gripping finger of the pick-up hand 31 contacts the workpiece 50, the number of gripping fingers, and the interval and distribution of the gripping fingers in a case where the pick-up hand 31 is of the gripping type. Note that the receiving unit 110 may receive such information in the form of a numerical value, but may receive the information in the form of a two-dimensional or three-dimensional graph (e.g., CAD data) or receive the information in the form of both a numerical value and a graph. The pick-up condition reflecting the received information is stored in the storage unit 14 as, e.g., a pick-up condition A where the workpiece is picked up using one suction pad having an outer shape with a diameter (hereinafter also referred to as “ø”) of 20 mm and having an air hole with ø8 mm.

The receiving unit 110 may receive the pick-up condition and store such a pick-up condition in the storage unit 14, the pick-up condition being input by the user via the input unit 12 and including the information on the contact normal direction of the portion of the pick-up hand 31 contacting the workpiece 50. Such contact normal direction information may be a three-dimensional vector indicating a contact normal direction of a portion, which contacts the workpiece 50, of the suction pad attached to a tip end of the air suction pick-up hand 31, or may be a three-dimensional vector indicating a contact normal direction of a portion, which contacts the workpiece 50, of the gripping finger of the gripping pick-up hand 31. Specifically, the contact normal direction information may be, in the storage unit 14, stored as one piece of three-dimensional direction vector information at each contact position. For example, one three-dimensional coordinate system Σ_{w} is defined taking the center of gravity of the workpiece as an origin. One three-dimensional coordinate system Σᵢ is defined taking a position coordinate value [xᵢ, yᵢ, zᵢ] of an i-th contact position on the three-dimensional coordinate system Σ_{w} as an origin and taking the longitudinal direction of the pick-up hand 31 as a positive direction of a z-axis. For example, in a case where the contact normal direction vector of the pick-up hand 31 points to a negative direction of the z-axis on the coordinate system Σᵢ, the contact normal direction vector of the pick-up hand 31 can be numerically stored as one three-dimensional direction vector [0, 0, -1], and information on a homogeneous transformation matrix T_{wi} of the coordinate systems Σ_{w}, Σᵢ can be received in the form of a numerical value and stored in the storage unit 14. The receiving unit 110 may receive the contact normal vector of the pick-up hand 31 three-dimensionally drawn in the form of a graph in the later-described preprocessing unit 111, and store such a contact normal vector in the storage unit 14. Needless to say, the receiving unit 110 may simultaneously receive the information in the form of both a numerical value and a graph, and store such information in the storage unit 14.

The receiving unit 110 may receive the pick-up condition and store such a pick-up condition in the storage unit 14, the pick-up condition being input by the user via the input unit 12 and including the information on the contact area of the portion of the pick-up hand 31 contacting the workpiece 50. For example, in a case where the workpiece 50 is gripped and picked up by the gripping pick-up hand 31 with two fingers, information on the area of a gripping portion of the gripping finger (e.g., an area of 600 mm² in the case of a rectangle of 30 mm × 20 mm) is stored. The receiving unit 110 may receive percentage information which is obtained in such a manner that the user determines an actual percentage of the area of the rectangular region at least necessary for gripping and picking up the workpiece 50 by contact with the workpiece 50 and which is input by the user via the input unit 12. Thus, in the case of a heavy workpiece 50, the percentage is increased to lift up the workpiece 50 with a larger contact area so that dropping of the workpiece 50 can be prevented. In the case of a light workpiece 50, the percentage is decreased so that more candidates for a local feature of the workpiece 50 can be acquired according to a smaller contact area.

The receiving unit 110 may receive the pick-up condition and store such a pick-up condition in the storage unit 14, the pick-up condition being input by the user via the input unit 12 and including the information on the movable range of the pick-up hand 31. Specifically, the receiving unit 110 may receive information and store such information in the storage unit 14, the information indicating a limit value of an operation parameter indicating the movable range of the pick-up hand 31, such as a limit range of a gripping width in an open/closed state in the case of the gripping pick-up hand 31, a limit range of an operation angle of each joint in a case where the pick-up hand 31 has an articulated structure, and a limit range of the angle of inclination of the pick-up hand 31 upon pick-up. Note that the receiving unit 110 may receive the information on the movable range of the pick-up hand 31 in the form of a numerical value, but may receive such information in the form of a two-dimensional or three-dimensional graph or may receive such information in the form of both a numerical value and a graph. The receiving unit 110 may store the pick-up condition reflecting the received information in the storage unit 14. For example, in a case where the angle of inclination of the pick-up hand 31 in pick-up operation is limited within a range of -30° to 30° in order to avoid collision with a surrounding obstacle such as a workpiece 50 or a wall of the container 60, the receiving unit 110 may store such a pick-up condition in the storage unit 14.

The receiving unit 110 may receive the pick-up condition and store such a pick-up condition in the storage unit 14, the pick-up condition including the information on the surface curvature of the workpiece 50 calculated by the later-described preprocessing unit 111 from a 3D CAD model of the workpiece 50. For example, the later-described preprocessing unit 111 may calculate, from the 3D CAD model of the workpiece 50, the amount of change in the curvature at each position on a workpiece surface from a difference between the curvature at such a position and the curvature at an adjacent position, and store the change amount in the storage unit 14.

The receiving unit 110 may receive the pick-up condition and store such a pick-up condition in the storage unit 14, the pick-up condition being input by the user via the input unit 12 and including the information on the material, density, and friction coefficient of the workpiece 50 and the distribution thereof. For example, the receiving unit 110 receives information and stores such information in the storage unit 14, the information including information on whether the material of the workpiece 50 is aluminum or plastic, information on the density and friction coefficient of the material, and information on distribution of various materials across the entire workpiece and distribution of the densities and friction coefficients of the materials in the case of the workpiece 50 having the plural types of materials. In this case, the later-described preprocessing unit 111 may cause the display unit 13 to display such distribution information in the form of a graph, such as coloring of different material regions in different colors, and may store, in the form of a numerical value, the information on the density, the friction coefficient, etc. according to the material in the storage unit 14.

The receiving unit 110 may receive the pick-up condition and store such a pick-up condition in the storage unit 14, the pick-up condition being input by the user via the input unit 12 and including the partial pick-up availability information on the workpiece 50. For example, the user visually checks the 3D CAD model of the workpiece 50 displayed on the display unit 13 by the later-described preprocessing unit 111, regards a hole, a groove, a step, a recess, etc. of the workpiece 50 which is a cause for air leakage upon pick-up by the air suction pick-up hand 31 as “unpickable”, and regards a local flat surface, a local curved surface, etc. of the workpiece 50 including no feature causing air leakage as “pickable”. In a case where the user surrounds each of these locations by a rectangular frame, the receiving unit 110 stores, in the storage unit 14, information on the position of the frame relative to the position of the center of gravity of the workpiece 50, the size of the frame, etc. In a case where the user regards a region for which contact needs to be avoided upon pick-up, such as a region with a product logo or a region with an electronic substrate pin as “unpickable”, and surrounds each of these locations by a rectangular frame on the 3D CAD model of the workpiece 50, the receiving unit 110 may store, in the storage unit 14, information on the position of the frame relative to the position of the center of gravity of the workpiece 50, the size of the frame, etc.

### <Preprocessing Unit 111>

The preprocessing unit 111 may have a virtual environment, such as 3D CAD software or a physical simulator, that derives the position of the center of gravity of the workpiece 50 based on the 3D CAD model of the workpiece 50.

Specifically, the preprocessing unit 111 may derive the position of the center of gravity of the workpiece 50 from the 3D CAD model of the workpiece 50, and cause the display unit 13 to display the position of the center of gravity of the workpiece 50, for example.

### <First Processing Unit 112>

The first processing unit 112 derives, based on the derived position of the center of gravity of the workpiece 50, the local feature of the 3D CAD model of the workpiece 50 according to the pick-up condition received by the receiving unit 110 via the input unit 12.

Specifically, the first processing unit 112 may derive, based on the information, i.e., the pick-up condition, received by the receiving unit 110 via the input unit 12 and including the information on the type of pick-up hand 31, the shape and size of the portion contacting the workpiece 50, etc., a local feature (a local curved or flat surface) of the 3D CAD model of the workpiece 50 matched with the shape of the contact portion of the pick-up hand 31. For example, in a case where the receiving unit 110 has received the pick-up condition A where the workpiece 50 is picked up by the pick-up hand 31 including one suction pad having the outer shape with ø20 mm and having the air hole with ø8 mm, the first processing unit 112 searches, by matching with the shape of the suction pad of the pick-up hand 31, local flat or curved surfaces of the 3D CAD model of the workpiece having ø20 mm or greater and having no element causing air leakage, such as a hole, a groove, a step, or a recess, in a region within ø8 mm about the center position of the suction pad. The first processing unit 112 calculates a distance from the center of gravity of the workpiece to each searched local flat or curved surface, and derives a local flat or curved surface having the distance not exceeding a preset acceptable threshold.

Based on the information, which is the pick-up condition received by the receiving unit 110 via the input unit 12, on the normal direction of the portion of the pick-up hand 31 contacting the workpiece 50, the first processing unit 112 may derive a local feature (a local curved or flat surface) of the 3D CAD model of the workpiece 50 matched with the contact normal direction of the pick-up hand 31.

Hereinafter, a method for deriving a local feature in (a) a case where the workpiece 50 is picked up using the air suction pick-up hand 31 having one suction pad and (b) a case where the workpiece 50 is picked up using the gripping pick-up hand 31 having a pair of gripping fingers (a parallel gripper) will be described.

### (A) Case Where Workpiece 50 Is Picked Up Using Suction Pick-Up Hand 31 Having One Suction Pad

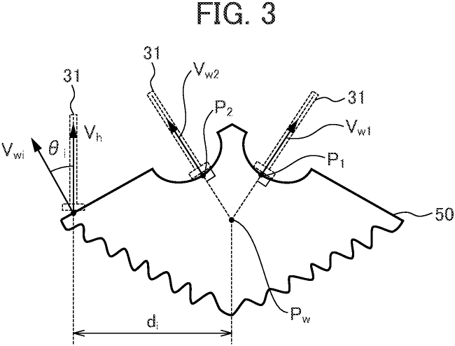

FIG. 3 is a view showing one example of the workpiece 50.

As shown in FIG. 3, the first processing unit 112 searches and derives, across the surface shape of the 3D CAD model of the workpiece 50, such local curved or flat surfaces of the workpiece 50 that an angle Θᵢ between a normal vector V_{wi} at the center position of a local feature (a curved or flat surface) and a contact normal vector Vₕ of the pick-up hand 31 (including the suction pad, indicated by a dashed line) is the minimum and a distance dᵢ from the position P_{w} of the center of gravity of the workpiece 50 to the contact normal vector Vₕ of the pick-up hand 31 is the minimum. In the case of FIG. 3, the local features passing through the center of gravity of the workpiece (i.e., the distance dᵢ is zero) and having zero angle Θᵢ between the normal vector V_{wi} and the contact normal vector Vₕ of the pick-up hand 31 are local curved surfaces about positions P₁, P₂ at which the normal vector V_{wi} is V_{w1} or V_{w2} as shown in FIG. 3. Note that the local features derived by the first processing unit 112 are not limited to two locations, and may be one location or three or more locations.

The air suction pick-up hand 31 picks up the workpiece 50 at the position P₁, P₂ derived as described above so that the suction pad can smoothly closely contact the surface of the workpiece 50 without shifting the position of the workpiece 50 by the pick-up hand 31. Since a moment generated about the center of gravity of the workpiece by contact force of the pick-up hand 31 is zero, unstable workpiece rotary motion upon lifting of the workpiece 50 can be reduced and the workpiece 50 can be stably picked up.

### (B) Case Where Workpiece 50 Is Picked Up Using Gripping Pick-Up hand 31 Having a Pair of Gripping Fingers (Parallel Gripper) 31a, 31b

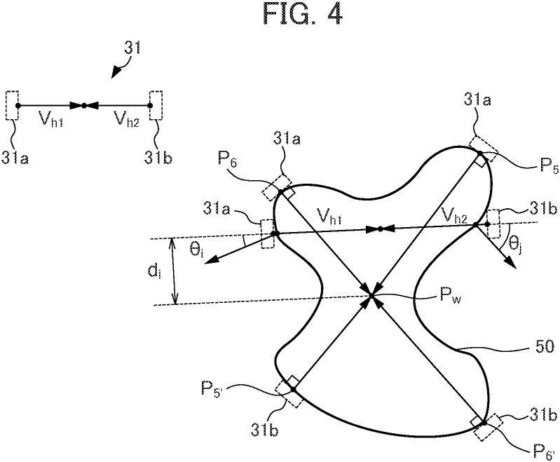

FIG. 4 is a view showing one example of the workpiece 50.

As shown in FIG. 4, the first processing unit 112 searches and derives, across the surface shape of the 3D CAD model of the workpiece 50, such local curved or flat surfaces of the workpiece 50 that the sum Θᵢⱼ (= Θᵢ + Θⱼ) of an angle Θᵢ between a normal vector V_{wi} at a location where one 31a of a pair of gripping fingers 31a, 31b (two dashed rectangles) of the pick-up hand 31 contacts a curved or flat surface of the workpiece 50 and a contact normal vector Vₕ₁ of the gripping finger 31a and an angle Θⱼ between a normal vector V_{wj} at a location where the other gripping finger 31b of the pick-up hand 31 contacts a curved or flat surface of the workpiece 50 and a contact normal vector Vₕ₂ of the gripping finger 31b is the minimum and a distance dᵢ from the position P_{w} of the center of gravity of the workpiece 50 to the contact normal vector Vₕ₁, Vₕ₂ of the gripping finger 31a, 31b is the minimum. In the case of FIG. 4, the local features which pass through the center of gravity of the workpiece 50 (i.e., the distance dᵢ is zero) and whose sum Θᵢⱼ of the angle Θᵢ between the normal vector V_{wi} and the contact normal vector Vₕ₁ of the gripping finger 31a and the angle Θⱼ between the normal vector V_{wj} and the contact normal vector Vₕ₂ of the gripping finger 31b is zero are local curved surfaces about positions P₅, P_{5′} and positions P₆, P_{6′}.

The pick-up hand 31 grips the workpiece 50 at the positions P₅, P_{5′} or the positions P₆, P_{6′} derived as described above in a gripping posture shown in FIG. 4 so that the pair of gripping fingers 31a, 31b can smoothly contact the workpiece 50 without shifting the position of the workpiece 50 upon contact with the workpiece 50. Consequently, the workpiece 50 can be stably gripped and picked up without rotary motion about the center of gravity of the workpiece when the workpiece 50 is gripped and picked up. Note that the local features derived by the first processing unit 112 are not limited to two sets, and may be one set or three or more sets.

Based on the information, which is the pick-up condition received by the receiving unit 110 via the input unit 12, on the contact area of the portion of the pick-up hand 31 contacting the workpiece 50, the first processing unit 112 may derive a local feature of the 3D CAD model of the workpiece 50. For example, in a case where the workpiece 50 is gripped and picked up by the gripping pick-up hand 31 having two fingers and the gripping portion of the gripping finger is in a rectangular shape of 30 mm × 20 mm, i.e., the contact area is 600 mm², when the receiving unit 110 has received, via the input unit 12, the pick-up condition where the percentage of the contact area exceeds 50%, the first processing unit 112 may search such local flat surfaces of the 3D CAD model of the workpiece 50 that the area exceeds 300 mm² because the actual contact area needs to exceed 300 mm². The first processing unit 112 may calculate a distance from the center of gravity of the workpiece to each searched local flat surface, and may derive a local flat surface having the distance not exceeding a preset acceptable threshold.

Using the limit value of the operation parameter, which is the pick-up condition received by the receiving unit 110 via the input unit 12, indicating the movable range of the pick-up hand 31, the first processing unit 112 may derive a local feature of the 3D CAD model of the workpiece 50. For example, in some cases, the user specifies and limits, in order to avoid collision with a surrounding obstacle such as the pick-up hand 31 or a wall of the container 60 when a target workpiece 50 is picked up, the angle of inclination of the pick-up hand 31 within a range of -30° to 30°. In this case, when the pick-up hand 31 picks up the workpiece 50 at a location where the angle between the normal direction of the flat or curved surface as the local feature derived by the above-described method and the vertical direction falls outside a range of -30° to 30°, the angle of inclination in hand operation falls outside an operation limit range of -30° to 30°. Thus, the first processing unit 112 may withdraw such a local feature from candidates.

Based on the information, which is the pick-up condition received by the receiving unit 110 via the input unit 12, on the surface curvature of the workpiece 50, the first processing unit 112 may derive a local feature of the 3D CAD model of the workpiece 50. For example, in a case where the workpiece 50 is picked up using the air suction pick-up hand 31 having one suction pad, the preprocessing unit 111 obtains the amount of change in the workpiece surface curvature on, e.g., the virtual space of the 3D CAD software or the three-dimensional physical simulator. Then, the first processing unit 112 may determine a local feature with a small amount of change in the curvature as a local flat surface or a gentle local curved surface, and may raise a priority of candidate selection and provide a high evaluation score. The first processing unit 112 may determine a local feature with a great amount of change in the curvature as an uneven local curved surface, and may lower the priority of candidate selection and provide a low evaluation score. The first processing unit 112 may determine a local feature with a rapidly- and drastically-changing amount of change in the curvature as one including a feature causing air leakage, such as a hole, a groove, a step, or a recess, and may provide an evaluation score of zero such that such a local feature is withdrawn from candidates. The first processing unit 112 may derive a local feature with the highest evaluation score as a candidate, but may derive a plurality of local features with scores exceeding a preset threshold. The first processing unit 112 may calculate a distance from the center of gravity of the workpiece to each of a plurality of local features satisfying an evaluation score threshold A, and may derive a local feature having the distance not exceeding a preset acceptable threshold B. Note that depending on an actual shape of the workpiece 50, one local feature or two or more local features may be derived.

Based on the distribution information, which is the pick-up condition received by the receiving unit 110 via the input unit 12, on the material, density, friction coefficient, etc. of the workpiece 50, the first processing unit 112 may derive a local feature of the 3D CAD model of the workpiece 50. For example, in the case of picking up a workpiece 50 formed by bonding of plural types of materials, a portion with a higher material density covers a higher percentage of the weight of the workpiece 50 and includes the center of gravity of the workpiece. Thus, based on the distribution information on the densities of various materials across the entirety of the workpiece 50, the pick-up hand 31 preferentially picks up the workpiece 50 at the portion with the higher material density so that the pick-up hand 31 can pick up the workpiece 50 at a position closer to the center of gravity of the workpiece. Consequently, the workpiece 50 can be more stably picked up. Using the distribution information on the friction coefficient, the pick-up hand 31 preferentially picks up the workpiece 50 at a portion with a higher friction coefficient so that the workpiece 50 can be, without slippage, more stably picked up.

Based on the partial pick-up availability information on the workpiece 50, which is the pick-up condition received by the receiving unit 110 via the input unit 12, the first processing unit 112 may derive a local feature of the 3D CAD model of the workpiece 50. For example, a hole, a groove, a step, a recess, etc. of the workpiece 50 as a cause for air leakage are regarded as “unpickable”, and a local flat surface, a local curved surface, etc. of the workpiece 50 including no feature causing air leakage is regarded as “pickable”. Using the pick-up availability information each surrounded by the rectangular frame, the first processing unit 112 may search local features of the 3D CAD model of the workpiece 50 matched with the feature in the frame from and derive such local features as favorable candidates. Then, for the plurality of local features derived as “pickable”, the first processing unit 112 may calculate a distance from the center position of each local feature to the center of gravity of the workpiece, and derive a local feature having the distance not exceeding a preset acceptable threshold. A region for which contact needs to be avoided upon pick-up, such as a region with a product logo or a region with an electronic substrate pin, may be regarded as “unpickable”. Using the pick-up availability information each surrounded by the rectangular frame, the first processing unit 112 may search local features of the 3D CAD model of the workpiece 50 matched with the feature in the frame and derive such local features as unfavorable candidates.

### <First Pick-Up Candidate Calculation Unit 113>

The first pick-up candidate calculation unit 113 may automatically calculate at least one candidate for the pick-up position of the workpiece 50 based on the local feature derived by the first processing unit 112.

Specifically, the first pick-up candidate calculation unit 113 may calculate the center position of a more-favorable local feature derived by the above-described method as a pick-up position candidate. When the pick-up hand 31 (of the air suction type or the griping type) picks up the workpiece 50 at such a position candidate, the pick-up hand 31 can smoothly contact the workpiece 50 with favorable fitting of the surface of the suction pad or the surfaces of the pair of gripping fingers contacting the workpiece 50 while air leakage and shift of the position of the workpiece 50 by the pick-up hand 31 are avoided. The pick-up hand 31 contacts and picks up the workpiece 50 at a position close to the center of gravity of the workpiece, and therefore, rotary motion about the center of gravity of the workpiece upon lifting can be prevented and the workpiece 50 can be stably picked up without collision with a surrounding obstacle such as a workpiece 50 or a wall of the container 60.

The first pick-up candidate calculation unit 113 may automatically calculate a candidate for the pick-up posture of the workpiece 50 based on the local feature derived by the first processing unit 112.

For example, when the pick-up hand 31 picks up the workpiece 50 at the pick-up position P₁, P₂ shown in FIG. 3 as described above, the first pick-up candidate calculation unit 113 may determine the posture of the pick-up hand 31 such that the pick-up hand 31 approaches the workpiece 50 in a state in which the pick-up hand 31 is inclined such that the normal vector V_{w1}, V_{w2} of the center position of the derived local curved surface and the contact normal vector Vₕ of the pick-up hand 31 are coincident with each other and the pick-up hand 31 contacts the workpiece 50 at the position P₁, P₂. When the pick-up hand 31 in such a derived pick-up posture approaches and picks up the workpiece 50, contact with the workpiece 50 at a position different from the intended position P₁, P₂ due to shift of the position of the workpiece 50 before contact at the position P₁, P₂ can be prevented. Dropping of the workpiece 50 caused by rotary motion about the center of gravity of the workpiece 50 upon lifting thereof due to contact at an unintended position can be prevented.

Note that the preprocessing unit 111 may draw, on, e.g., the virtual space of the 3D CAD software or the three-dimensional physical simulator, the information on the pick-up hand 31 as the pick-up condition received by the receiving unit 110 via the input unit 12 and the pick-up position and posture candidates calculated by the first pick-up candidate calculation unit 113 and cause the display unit 13 to display such information.

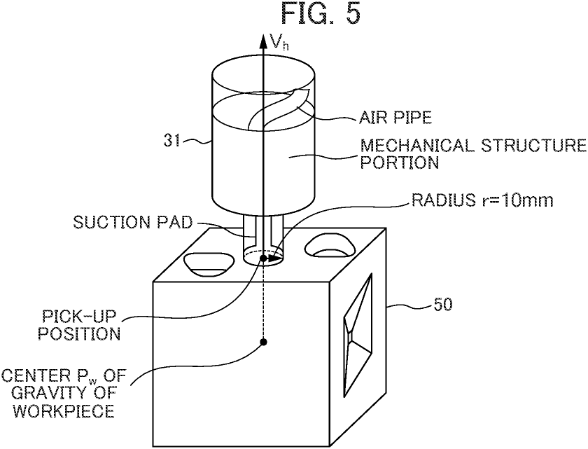

FIG. 5 is a view showing one example of the drawing on the virtual space.

For example, in FIG. 5, based on a pick-up condition where an aluminum workpiece 50 is picked up using a pick-up hand 31 including one suction pad having an outer shape with ø20 mm, the pick-up position candidate calculated by the first pick-up candidate calculation unit 113 is at the center of a bottom surface of the suction pad, the radius of the bottom surface is ø10 mm, the normal direction of a tangent plane between the bottom surface and the workpiece 50 is taken as the normal direction of the pick-up hand 31, and the entirety of the tip end of the pick-up hand 31 including the suction pad, an air pipe, etc. is drawn in the shape of a three-dimensional stepped cylinder as a virtual hand region and is displayed together with the 3D CAD model of the workpiece 50.

Note that the first pick-up candidate calculation unit 113 may detect, using an interference checking function of the preprocessing unit 111 or a collision calculation function of the physical simulation, whether or not there is interference or collision among the virtual hand three-dimensionally displayed and other portions of the workpiece 50, thereby correcting the pick-up position and posture candidates. Specifically, the preprocessing unit 111 checks the interference or senses the collision for a state (e.g., the state shown in FIG. 5) in which the three-dimensional virtual hand contacts the workpiece 50 at the pick-up position candidate calculated by the first pick-up candidate calculation unit 113, and causes the display unit 13 to display, including a result thereof, the three-dimensional virtual hand and the workpiece 50. Based on the result of interference checking or collision sensing for the three-dimensional virtual hand and the 3D CAD model of the workpiece 50 on the display unit 13, the user may check such a result while changing the viewpoint, delete a position candidate at an interference- or collision-detected position, and reflect such a result on the first pick-up candidate calculation unit 113. The first pick-up candidate calculation unit 113 may automatically delete a candidate at an interference- or collision-detected position. With this configuration, the first pick-up candidate calculation unit 113 can calculate data on which only a pick-up position candidate is reflected, no interference between the virtual hand and the workpiece 50 itself being detected at the pick-up position candidate, i.e., the pick-up hand 31 not being interfered with the workpiece 50 itself when actually picking up the workpiece 50 at the pick-up position candidate.

The first pick-up candidate calculation unit 113 may cause the display unit 13 to display, in the form of a graph, the candidate for which the interference or the collision has been sensed by the preprocessing unit 111, cause the display unit 13 to display a message (e.g., “Adjust pick-up position or posture indicated by this candidate so that interference can be eliminated”) for instructing the user to correct the pick-up position or posture indicated by the candidate such that the interference between the displayed virtual hand and a surrounding obstacle is eliminated to provide the message to the user, and prompt the user to input the pick-up position or posture corrected by the user. In this manner, the candidate adjusted by the user may be reflected.

### <Second Pick-Up Candidate Calculation Unit 114>

Based at least on the pick-up position candidate calculated by the first pick-up candidate calculation unit 113, the second pick-up candidate calculation unit 114 may automatically generate at least the pick-up positions of the plurality of workpieces 50 loaded in bulk and overlapping with each other.

Specifically, based on the position and posture candidates calculated by the first pick-up candidate calculation unit 113, the second pick-up candidate calculation unit 114 may automatically generate the pick-up positions and postures of the plurality of workpieces 50 in a state, which is generated by the preprocessing unit 111, in which the plurality of workpieces 50 is randomly loaded in bulk and overlap with each other. That is, for a state in which the 3D CAD models of the plurality of workpieces 50 overlap with each other, the second pick-up candidate calculation unit 114 specifies each workpiece 50 (an exposed portion thereof), derives a local feature of each specified workpiece 50 (the exposed portion thereof), and calculates the center position of the local feature of the workpiece 50 as a pick-up position candidate.

For example, the preprocessing unit 111 randomly generates the overlapping state of the plurality of workpieces 50 on, e.g., the virtual space of the 3D CAD software or the three-dimensional physical simulator by means of the 3D CAD models of the workpieces 50 with the information on the more-favorable pick-up position and posture candidates calculated by the first pick-up candidate calculation unit 113. The position and posture candidates calculated by the first pick-up candidate calculation unit 113 are favorable candidates in a case where the 3D CAD model of one workpiece 50 is viewed from an optional direction within a range of 360 degrees, but there is a probability that these position and posture candidates are not exposed in the overlapping state of the plurality of workpieces 50 because the position and posture candidates are covered with a surrounding workpiece 50 or the workpiece 50 itself. The second pick-up candidate calculation unit 114 draws the above-described virtual hands in the pick-up postures calculated by the first pick-up candidate calculation unit 113 at the pick-up positions calculated by the first pick-up candidate calculation unit 113 in the overlapping state of the plurality of workpieces 50 generated by the preprocessing unit 111, and using, e.g., the interference checking function of the 3D CAD software as the preprocessing unit 111 or the collision calculation function of the three-dimensional physical simulator as the preprocessing unit 111, checks whether or not there is the interference or the collision between the virtual hand and a surrounding obstacle such as a workpiece 50 or a wall of the container 60. The second pick-up candidate calculation unit 114 may automatically delete a candidate at a position for which the interference or the collision has been detected by the preprocessing unit 111, but instead of deletion of the candidate, may cause the display unit 13 to display a message for instructing the user to adjust the position and posture candidates such that the interference or the collision is eliminated to provide the message to the user. Alternatively, the second pick-up candidate calculation unit 114 may shift position and posture candidates, e.g., shift a position candidate at an interval of 2 mm and/or shift a posture candidate at an interval of 2 degrees, automatically adjust the position and posture candidates until no interference or collision is detected under a searching condition where the maximum position shift amount is ±10 mm or less and the maximum posture shift amount is within ± 10 degrees, and if adjustment cannot be made to satisfy the searching condition, automatically delete the position and posture candidates. With this configuration, the second pick-up candidate calculation unit 114 can reflect a more-favorable candidate result calculated by the first pick-up candidate calculation unit 113, and calculate more-favorable candidates for the positions and postures of the plurality of workpieces 50 without the interference with a surrounding obstacle in the overlapping state of the plurality of workpieces 50 generated by the preprocessing unit 111.

The second pick-up candidate calculation unit 114 may cause the display unit 13 to display, in the form of a graph, pick-up position and posture candidates for which the interference or the collision has been sensed, prompt the user to correct these candidates such that the interference between the displayed virtual hand and a surrounding obstacle such as a workpiece 50 or a wall of the container 60 is eliminated, and reflect the pick-up position and posture corrected by the user.

### <First Training Data Generation Unit 115>

The first training data generation unit 115 generates training data based on two-dimensional projection images projected from the randomly-overlapping state of the plurality of workpieces 50 generated by the preprocessing unit 111 and the information including at least the pick-up position candidates of the plurality of workpieces 50 generated by the second pick-up candidate calculation unit 114.

Specifically, the first training data generation unit 115 may generate and output the training data by means of 3D CAD data with the pick-up position candidates calculated by the second pick-up candidate calculation unit 114 and the hand information. The preprocessing unit 111 randomly generates plural pieces of 3D CAD data on the overlapping state of the plurality of workpieces 50 on, e.g., the virtual space of the 3D CAD software or the three-dimensional physical simulator by means of the 3D CAD data with the pick-up position candidates and the hand information.

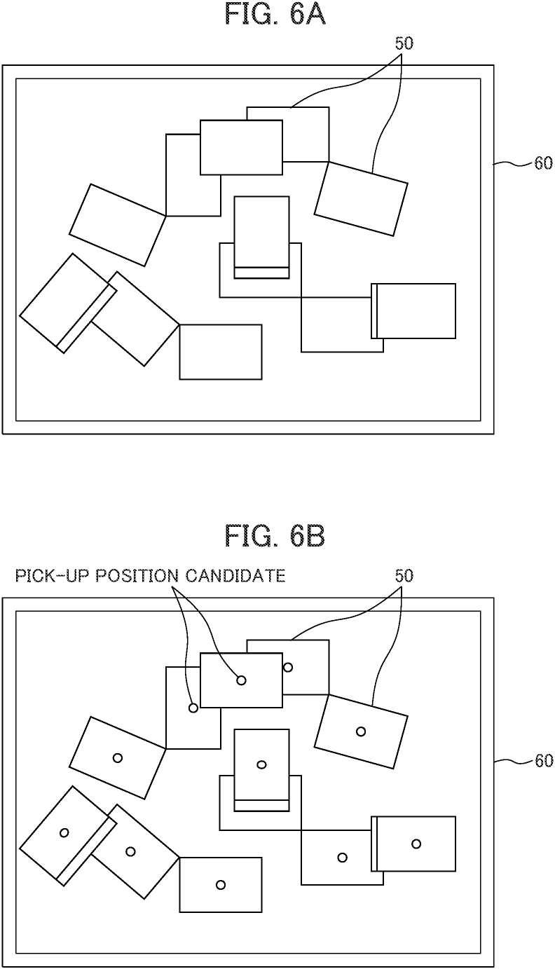

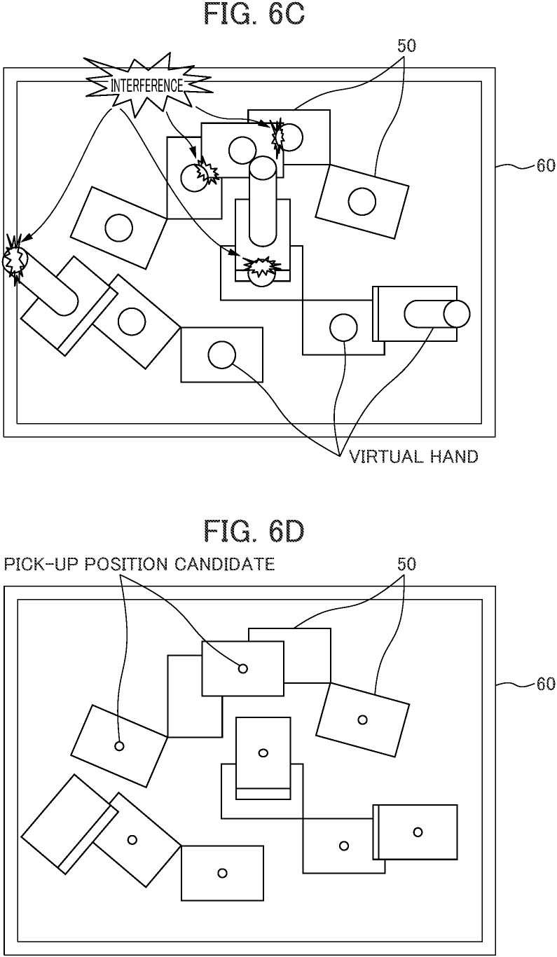

FIG. 6A is a view showing one example of a 2D CAD diagram obtained by projection of the 3D CAD data on the randomly-generated overlapping state of the plurality of workpieces 50.

As described above, the user may check, by the second pick-up candidate calculation unit 114, whether or not the three-dimensional virtual hand (e.g., the three-dimensional stepped cylinder of FIG. 5) displayed in contact with the pick-up position candidate of each workpiece 50 interferes with a surrounding obstacle in a state in which the plurality of workpieces 50 in the plural pieces of 3D CAD data generated overlap with each other while changing the viewpoint, and may delete a position candidate for which the interference with the surrounding obstacle such as a workpiece 50 or a wall of the container 60 has been detected. The candidate for which the interference or the collision has been detected may be automatically deleted using the interference checking function of the 3D CAD software or the collision calculation function of the three-dimensional physical simulator, as described above. With this configuration, the 3D CAD data can be generated, the 3D CAD data reflecting only such a pick-up position candidate that there is no interference between the virtual hand and the surrounding environment, i.e., there is no interference between the pick-up hand 31 and an obstacle around a target workpiece 50 when the pick-up hand 31 actually picks up the workpiece 50 at the pick-up position candidate.

FIG. 6B is a view showing one example of a 2D CAD diagram obtained by projection of the 3D CAD data with the pick-up position candidate data calculated by the first pick-up candidate calculation unit 113. FIG. 6C is a view showing one example of a 2D CAD diagram obtained by projection of the 3D CAD data with the cylindrical virtual hand drawn at each pick-up position candidate. FIG. 6D is a view showing one example of a 2D CAD diagram obtained by projection of the 3D CAD data with the pick-up position candidate data after candidates for which the interference had been detected has been deleted.

The first training data generation unit 115 determines, according to the relative positions and postures of a camera (the imaging device 40 shown in FIG. 1), the container 60, and a tray (not shown) in a real world, the position and posture of a virtual camera on the virtual space to set the position and the posture from the viewpoint in projection in advance, projects, from the set viewpoint in projection, each of the plural pieces of 3D CAD data on the randomly-overlapping state of the plurality of workpieces 50 generated by the preprocessing unit 111 as described above onto a virtual camera image plane, and extracts the plurality of 2D CAD diagrams generated by projection of the randomly-generated overlapping state as shown in FIGS. 6A to 6D.

Then, targeting for the plurality of 2D CAD diagrams as shown in FIG. 6A, the first training data generation unit 115 generates the training data (“teacher data”), taking, as label data, the plurality of 2D CAD diagrams (the two-dimensional projection images) of FIG. 6D with the pick-up position candidate data calculated by the second pick-up candidate calculation unit 114. The first training data generation unit 115 stores the generated training data (“teacher data”) as the training data 142 in the storage unit 14.

The training processing unit 116 executes machine learning by means of the training data (“teacher data”) generated by the first training data generation unit 115, and by means of the input of the two-dimensional images captured by the imaging device 40, generates a trained model for outputting the pick-up position of the workpiece 50 satisfying the pick-up condition input by the user without the interference between the pick-up hand 31 of the robot 30 and the surrounding environment. The training processing unit 116 stores the generated trained model in the storage unit 14, for example.

Note that supervised learning well-known by those skilled in the art, such as a neural network or a support vector machine (SVM), can be used as the machine learning executed by the training processing unit 116 and detailed description thereof will be omitted.

For example, the pick-up position selection unit 117 selects, by means of the input of the two-dimensional image captured by the imaging device 40 to the trained model generated by the training processing unit 116, the pick-up position of the workpiece 50 satisfying the pick-up condition input by the user without the interference between the pick-up hand 31 of the robot 30 and the surrounding environment. The pick-up position selection unit 117 outputs the selected pick-up position of the workpiece 50 to the robot control device 20.

### <Training Data Generation Processing of Information Processing Device 10>

Next, operation relating to training data generation processing of the information processing device 10 according to the present embodiment will be described.

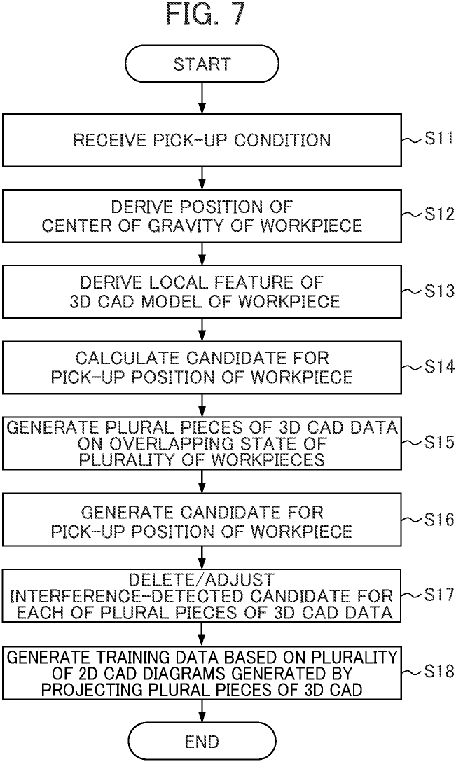

FIG. 7 is a flowchart for describing the training data generation processing of the information processing device 10.

In Step S11, the receiving unit 110 receives the pick-up condition input by the user via the input unit 12 and including the information on the type of pick-up hand 31, the shape and size of the portion contacting the workpiece 50, etc.

In Step S12, the preprocessing unit 111 derives the position of the center of gravity of the workpiece 50 by means of the 3D CAD model of the workpiece 50.

In Step S13, the first processing unit 112 derives, based on the position of the center of gravity of the workpiece 50 calculated in Step S12, the local feature of the 3D CAD model of the workpiece 50 according to the pick-up condition received in Step S11.

In Step S14, the first pick-up candidate calculation unit 113 calculates the candidate for the pick-up position of the workpiece 50 based on the local feature derived in Step S13.

In Step S15, the preprocessing unit 111 generates the plural pieces of 3D CAD data on the randomly-overlapping state of the plurality of workpieces 50 on, e.g., the virtual space of the 3D CAD software or the three-dimensional physical simulator by means of the 3D CAD data with the pick-up position candidate and the hand information.

In Step S16, the second pick-up candidate calculation unit 114 generates, based on the pick-up position candidate calculated in Step S14, the candidate for the pick-up position of the workpiece 50 in each of the plural pieces of 3D CAD data generated in Step S15.

In Step S17, the first pick-up candidate calculation unit 113 deletes/adjusts the candidate for which the interference has been detected on each of the plural pieces of 3D CAD data by means of the interference checking function of the 3D CAD software as the preprocessing unit 111 or the collision calculation function of the three-dimensional physical simulator as the preprocessing unit 111.

In Step S18, the first training data generation unit 115 projects each of the plural pieces of 3D CAD data generated in Step S15 onto the virtual camera image plane, and targeting for the plurality of 2D CAD diagrams generated by projection, generates the training data (“teacher data”) with the label data which is the plurality of 2D CAD diagrams (the two-dimensional projection images) with the pick-up position candidate data calculated in Step S16.

As described above, the information processing device 10 according to the first embodiment receives the pick-up condition, and based on the position of the center of gravity of the workpiece 50 derived from the 3D CAD model of the workpiece 50, derives the local feature of the 3D CAD model of the workpiece 50 according to the received pick-up condition. The information processing device 10 calculates the candidate for the pick-up position of the workpiece 50 based on the derived local feature. The information processing device 10 randomly generates the plural pieces of 3D CAD data on the overlapping state of the plurality of workpieces 50 on the virtual space by means of the 3D CAD data with the pick-up position candidate and the hand information, thereby generating the candidate for the pick-up position for each of the plural pieces of 3D CAD data. Targeting for the plurality of 2D CAD diagrams generated by projection of the plural pieces of 3D CAD data, the information processing device 10 generates the training data (“teacher data”) with the label data which is the plurality of 2D CAD diagrams (the two-dimensional projection images) with the generated pick-up position candidate data.

With this configuration, the information processing device 10 can easily generate the training data (“teacher data”) necessary for generation of the trained model for specifying the pick-up positions of the plurality of workpieces 50 loaded in bulk.

The first embodiment has been described above.

### Second Embodiment

Next, the second embodiment will be described. As described above, in the first embodiment, in the training data (“teacher data”) generation processing, the state in which the workpieces 50 are loaded in bulk and overlap with each other is randomly generated on the virtual space by means of the 3D CAD data on the workpieces, and targeting for the plurality of 2D CAD diagrams obtained by projection of each of the plural pieces of 3D CAD data on the randomly-generated overlapping state of the plurality of workpieces 50, the training data is generated with the label data which is the plurality of two-dimensional projection images with the pick-up position candidate data generated on the workpiece 50 in each of the plural pieces of 3D CAD data. On the other hand, the second embodiment is different from the first embodiment in that targeting for a plurality of two-dimensional images, which is acquired by an imaging device 40, of a plurality of workpieces 50 loaded in bulk and overlapping with each other, training data is generated with label data which is a plurality of two-dimensional images with pick-up position candidate data calculated on the workpieces 50 based on a feature on each of the plurality of two-dimensional images and a feature of a 3D CAD model of the workpiece 50.

With this configuration, an information processing device 10a can easily generate the training data (“teacher data”) necessary for generation of a trained model for specifying the pick-up positions of the plurality of workpieces 50 loaded in bulk.

Hereinafter, the second embodiment will be described.

A robot system 1 according to the second embodiment has, as in the case of the first embodiment of FIG. 1, the information processing device 10a, a robot control device 20, a robot 30, the imaging device 40, the plurality of workpieces 50, and a container 60.

### <Information Processing Device 10a>

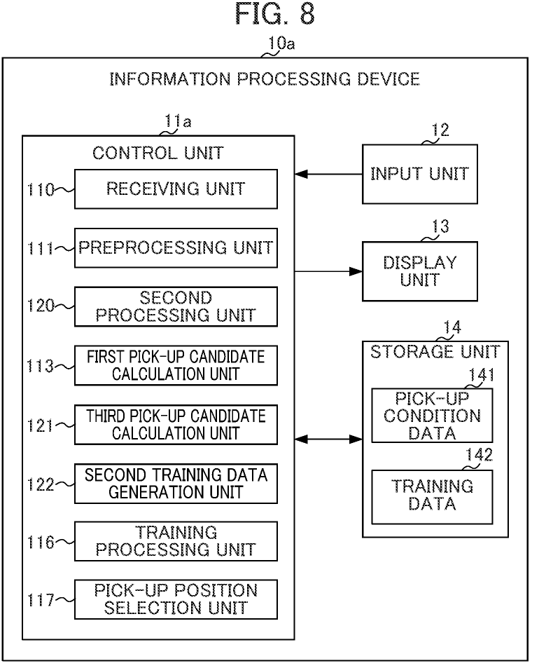

FIG. 8 is a functional block diagram showing a functional configuration example of the information processing device 10a according to the second embodiment. Note that the same reference numerals are used to represent elements having functions similar to those of the information processing device 10 of FIG. 1 and detailed description thereof will be omitted.

As in the information processing device 10 according to the first embodiment, the information processing device 10a has a control unit 11a, an input unit 12, a display unit 13, and a storage unit 14. The control unit 11a has a receiving unit 110, a preprocessing unit 111, a second processing unit 120, a first pick-up candidate calculation unit 113, a third pick-up candidate calculation unit 121, a second training data generation unit 122, a training processing unit 116, and a pick-up position selection unit 117.

The input unit 12, the display unit 13, and the storage unit 14 have functions similar to those of the input unit 12, the display unit 13, and the storage unit 14 according to the first embodiment.

The receiving unit 110, the preprocessing unit 111, the first pick-up candidate calculation unit 113, the training processing unit 116, and the pick-up position selection unit 117 have functions similar to those of the receiving unit 110, the preprocessing unit 111, the first pick-up candidate calculation unit 113, the training processing unit 116, and the pick-up position selection unit 117 according to the first embodiment.

For example, the second processing unit 120 may process the two-dimensional image acquired by the imaging device 40 as an information acquisition unit to extract a feature, thereby performing matching processing between the extracted feature and the feature of the 3D CAD model of the workpiece 50.

Specifically, the second processing unit 120 processes the acquired two-dimensional image (e.g., a two-dimensional image similar to the 2D CAD diagram shown in FIG. 6A and captured in a real world), thereby extracting the feature on the two-dimensional image, such as an edge, a corner, a circular portion, a hole, a groove, or a protrusion. For example, for each cell of the two-dimensional image divided into cells with a pixel size, the second processing unit 120 may calculate intensity gradients of adjacent cells to extract a histograms-of-oriented-gradients (HOG) feature amount, and identify, as an edge, a boundary with a great difference in a brightness or a pixel value. The second processing unit 120 may extract the feature from the two-dimensional image by means of image processing such as contour detection by a Canny edge detector, corner detection by a Harris corner detector, or circle detection by Hough transform. Note that these types of image processing are well-known by those skilled in the art and detailed description thereof will be omitted.

The second processing unit 120 searches a similar pattern on the 3D CAD model of the workpiece 50 based on the plurality of local features extracted by image processing and a relative positional relationship thereamong. When the degree of similarity of the searched similar pattern exceeds a certain threshold set in advance, the second processing unit 120 may determine that these local features are matched.

Note that in the robot system 1 according to the second embodiment, the imaging device 40 as the information acquisition unit may include, but not limited to, a visible light camera such as a black/white camera or an RGB color camera, an infrared camera that images a workpiece such as a heated high-temperature iron pole, and an ultraviolet camera that captures an ultraviolet image to allow inspection for a defect which is not visible with visible light, for example. For example, the information acquisition unit may include, for example, a stereo camera, a single camera and a distance sensor, a single camera and a laser scanner, and a single camera mounted on a movement mechanism, and may acquire plural pieces of three-dimensional point cloud data on a region where the workpieces 50 are present. The imaging device 40 as the information acquisition unit may capture a plurality of images of the region where the workpieces 50 are present, but may capture an image of a background region (e.g., an empty container 60 or a not-shown empty tray) where no workpieces 50 are present.

The third pick-up candidate calculation unit 121 may automatically generate, based on a processed result obtained by the second processing unit 120 and at least a pick-up position candidate calculated by the first pick-up candidate calculation unit 113, at least the pick-up positions of the workpieces 50 on the two-dimensional images acquired by the imaging device 40 as the information acquisition unit.

Specifically, using the processed result obtained by the second processing unit 120, the third pick-up candidate calculation unit 121 arranges the 3D CAD models of the plurality of workpieces 50 on a plurality of two-dimensional image planes and projects these models multiple times such that the matched features of the 3D CAD models of the workpieces 50 are arranged at the same positions in the same postures as those of the features of the workpieces 50 extracted by image processing for the plurality of two-dimensional images acquired by the imaging device 40. In this manner, the third pick-up candidate calculation unit 121 can calculate the two-dimensional pick-up position of the workpiece 50 on each two-dimensional image from the candidates for the three-dimensional pick-up position of the 3D CAD model of the workpiece calculated by the first pick-up candidate calculation unit 113.

The preprocessing unit 111 generates, based on the processed result obtained by the second processing unit 120, the overlapping state of the plurality of workpieces 50 corresponding to the two-dimensional images acquired by the imaging device 40 as the information acquisition unit. The third pick-up candidate calculation unit 121 may correct at least the pick-up positions of the plurality of workpieces 50 generated by the third pick-up candidate calculation unit 121 by means of an interference checking function or a collision calculation function.

With this configuration, a candidate at a position for which interference or collision has been sensed may be automatically deleted, and such deletion may be reflected on the two-dimensional image. Alternatively, a user may visually check the overlapping state of the plurality of workpieces 50 on the two-dimensional images, and delete a pick-up position candidate covered with other workpieces 50. In a case where the imaging device 40 as the information acquisition unit has acquired the three-dimensional point cloud data by a three-dimensional measuring machine such as a stereo camera, a pick-up position candidate positioned below other workpieces 50 may be automatically deleted using the three-dimensional point cloud data.

The second training data generation unit 122 may generate the training data (“teacher data”) based on the images acquired by the imaging device 40 as the information acquisition unit and the information including at least the pick-up position candidate calculated by the third pick-up candidate calculation unit 121.

For example, the second training data generation unit 122 can automatically label, using at least the pick-up position candidate calculated by the third pick-up candidate calculation unit 121, the pick-up position candidate on each two-dimensional image captured by the imaging device 40, as shown in FIG. 6D. Targeting for the plurality of two-dimensional images acquired by the imaging device 40, the second training data generation unit 122 generates the training data (“teacher data”) with label data which is a plurality of two-dimensional images with pick-up position candidate data reflecting only the pick-up position candidates for which no interference with surrounding environment has been detected. The second training data generation unit 122 stores the generated training data (“teacher data”, “training data”) as training data 142 in the storage unit 14.

### <Training Data Generation Processing of Information Processing Device 10a>

Next, operation relating to training data generation processing of the information processing device 10a according to the second embodiment will be described.

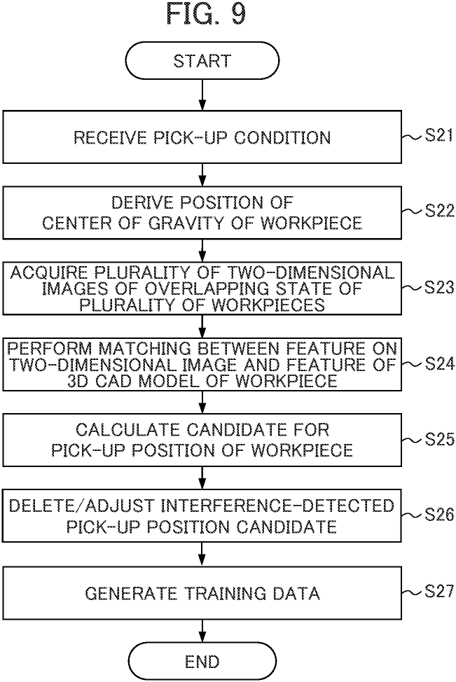

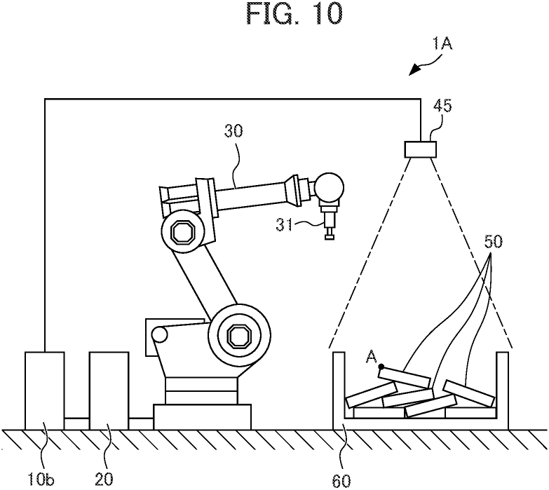

FIG. 9 is a flowchart for describing the training data generation processing of the information processing device 10a. Note that the processing in Steps S21, S22 is similar to that in Steps S11, S12 according to the first embodiment and description thereof will be omitted.

In Step S23, the second processing unit 120 acquires, from the imaging device 40, the plurality of two-dimensional images of the overlapping state of the plurality of workpieces 50 acquired by the imaging device 40.

In Step S24, the second processing unit 120 extracts the feature by processing each of the plurality of two-dimensional images acquired in Step S23 to perform the matching processing between the extracted feature of each two-dimensional image and the feature of the 3D CAD model of the workpiece 50, thereby matching the workpiece 50 on the two-dimensional image and the 3D CAD model of the workpiece 50 with each other.

In Step S25, the third pick-up candidate calculation unit 121 calculates, based on the matching relationship, which has been derived in Step S24, between the workpiece 50 on the two-dimensional image and the 3D CAD model of the workpiece 50, the candidate for the two-dimensional pick-up position of the workpiece 50 on the two-dimensional image from the candidate for the three-dimensional pick-up position of the workpiece 50 calculated by the first pick-up candidate calculation unit 113.

In Step S26, the preprocessing unit 111 generates, based on the processed result obtained by the second processing unit 120, the overlapping state of the plurality of workpieces 50 corresponding to the two-dimensional images. Using the interference checking function or the collision calculation function of the preprocessing unit 111, the third pick-up candidate calculation unit 121 deletes/adjusts the pick-up position candidate for which the interference or the collision has been detected, and reflects such a deletion/adjustment result on the two-dimensional images. Alternatively, the preprocessing unit 111 displays, via the display unit 13, each two-dimensional image with the pick-up position candidate information, the user visually checks the overlapping state of the plurality of workpieces 50 on the two-dimensional images, and the preprocessing unit 111 deletes/adjusts the interference-detected pick-up position candidate covered with other workpieces 50 to reflect such a result on the third pick-up candidate calculation unit 121.

In Step S27, the second training data generation unit 122 generates, targeting for the plurality of two-dimensional images acquired in Step S23, the training data (“teacher data”) with the label data which is the plurality of two-dimensional images with the pick-up position candidate data for which no interference with a surrounding obstacle has been detected.

As described above, the information processing device 10a according to the second embodiment processes the two-dimensional images of the overlapping state of the plurality of workpieces 50 acquired by the imaging device 40, thereby extracting the features on the two-dimensional images. The information processing device 10a performs the matching processing between each extracted feature and the feature of the 3D CAD model of the workpiece 50, thereby matching the workpiece 50 on each two-dimensional image and the 3D CAD model of the workpiece 50 with each other. The information processing device 10a calculates, based on the derived matching relationship between the workpiece 50 on each two-dimensional image and the 3D CAD model of the workpiece 50, the candidate for the two-dimensional pick-up position of the workpiece 50 on the two-dimensional image. Based on the derived matching relationship between the workpiece 50 on the two-dimensional image and the 3D CAD model of the workpiece 50 and the calculated pick-up position candidate, the information processing device 10a generates, targeting for the plurality of two-dimensional images acquired by the imaging device 40, the training data (“teacher data”) with the label data which is the plurality of two-dimensional images with the pick-up position candidate data for which no interference with a surrounding obstacle has been detected.

With this configuration, the information processing device 10a can easily generate the training data (“teacher data”) necessary for generation of the trained model for specifying the pick-up positions of the workpieces 50 loaded in bulk.

The second embodiment has been described above.

### Third Embodiment

Next, the third embodiment will be described. As described above, in the first embodiment, in the training data (“teacher data”, “training data”) generation processing, the state in which the workpieces 50 are loaded in bulk and overlap with each other is randomly generated on the virtual space by means of the 3D CAD data on the workpieces, and targeting for the plurality of 2D CAD diagrams (the two-dimensional projection images) obtained by projection of each of the plural pieces of 3D CAD data on the randomly-generated overlapping state of the plurality of workpieces 50, the training data is generated with the label data which is the plurality of two-dimensional projection images with the pick-up position candidate data generated on the workpiece 50 in each of the plural pieces of 3D CAD data. In the second embodiment, targeting for the plurality of two-dimensional images, which is acquired by the imaging device 40, of the plurality of workpieces 50 loaded in bulk and overlapping with each other, the training data is generated with the label data which is the plurality of two-dimensional images with the pick-up position candidate data calculated on the workpieces 50 based on the feature on each of the plurality of two-dimensional images and the feature of the 3D CAD model of each workpiece 50. On the other hand, the third embodiment is different from the first embodiment and the second embodiment in that targeting for plural pieces of three-dimensional point cloud data acquired on a plurality of workpieces 50 loaded in bulk and overlapping with each other by a three-dimensional measuring machine 45, training data is generated with label data which is plural pieces of three-dimensional point cloud data with pick-up position candidate data calculated on the workpieces 50 based on each of the plural pieces of three-dimensional point cloud data and 3D CAD data on the workpieces 50.

With this configuration, an information processing device 10b according to the third embodiment can easily generate the training data (“teacher data”) necessary for generation of a trained model for specifying the pick-up positions of the workpieces 50 loaded in bulk.

Hereinafter, the third embodiment will be described.

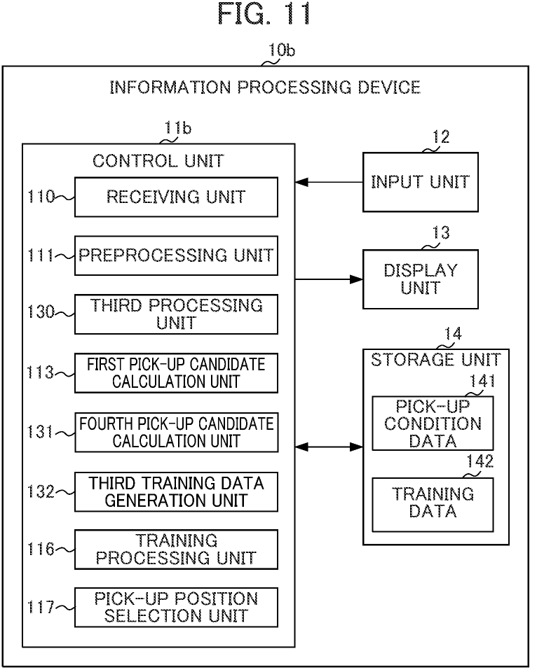

FIG. 10 is a view showing one example of a configuration of a robot system 1A according to the third embodiment. Note that the same reference numerals are used to represent elements having functions similar to those of the robot system 1 of FIG. 1 and detailed description thereof will be omitted.

As shown in FIG. 10, the robot system 1A has the information processing device 10b, a robot control device 20, a robot 30, the three-dimensional measuring machine 45, the plurality of workpieces 50, and a container 60.

The robot control device 20 and the robot 30 have functions similar to those of the robot control device 20 and the robot 30 according to the first embodiment.

The three-dimensional measuring machine 45 may acquire three-dimensional information (hereinafter also referred to as a “distance image”) obtained taking, as a pixel value, a value converted from a distance between a plane perpendicular to the optical axis of the three-dimensional measuring machine 45 and each point on surfaces of the workpieces 50 loaded in bulk in the container 60. For example, as shown in FIG. 10, a pixel value of a point A on the workpiece 50 on the distance image is converted from a distance between the three-dimensional measuring machine 45 and the point A on the workpiece 50 in a Z-axis direction of a three-dimensional coordinate system (X, Y, Z) of the three-dimensional measuring machine 45. That is, the Z-axis direction of the three-dimensional coordinate system is an optical axis direction of the three-dimensional measuring machine 45. The three-dimensional measuring machine 45 such as a stereo camera may acquire the three-dimensional point cloud data on the plurality of workpieces 50 loaded in the container 60. The three-dimensional point cloud data acquired as described above is discretized data which can be displayed in a 3D view viewable from any viewpoint in a three-dimensional space. With such data, the overlapping state of the plurality of workpieces 50 loaded in the container 60 can be three-dimensionally checked.

Note that the three-dimensional measuring machine 45 may acquire, in addition to the distance image, a two-dimensional image such as a gray scale image or an RGB image.

### <Information Processing Device 10b>

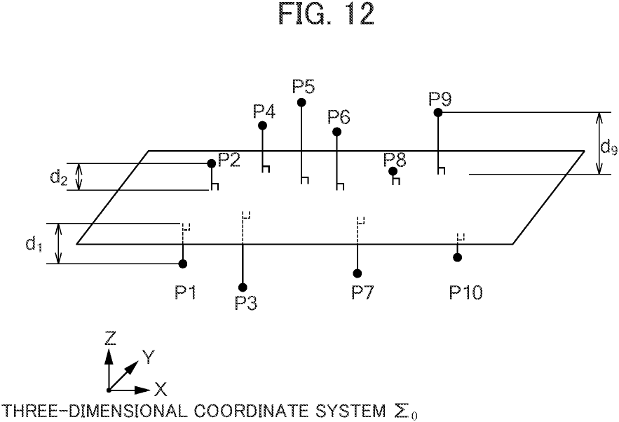

FIG. 11 is a functional block diagram showing a functional configuration example of the information processing device 10b according to the third embodiment. Note that the same reference numerals are used to represent elements having functions similar to those of the information processing device 10 of FIG. 1 and detailed description thereof will be omitted.

The information processing device 10b has, as in the information processing device 10 according to the first embodiment, a control unit 11b, an input unit 12, a display unit 13, and a storage unit 14. The control unit 11b has a receiving unit 110, a preprocessing unit 111, a third processing unit 130, a first pick-up candidate calculation unit 113, a fourth pick-up candidate calculation unit 131, a third training data generation unit 132, a training processing unit 116, and a pick-up position selection unit 117.

The input unit 12, the display unit 13, and the storage unit 14 have functions similar to those of the input unit 12, the display unit 13, and the storage unit 14 according to the first embodiment.

The receiving unit 110, the preprocessing unit 111, the first pick-up candidate calculation unit 113, the training processing unit 116, and the pick-up position selection unit 117 have functions similar to those of the receiving unit 110, the preprocessing unit 111, the first pick-up candidate calculation unit 113, the training processing unit 116, and the pick-up position selection unit 117 according to the first embodiment.

For example, in the case of acquiring plural pieces of three-dimensional point cloud data on a region where the workpieces 50 are present by the three-dimensional measuring machine 45 as an information acquisition unit, the third processing unit 130 may perform matching processing between the three-dimensional point cloud data and the 3D CAD model of the workpiece 50.

FIG. 12 is a view showing one example for describing preprocessing for the three-dimensional point cloud data.

Specifically, as shown in, e.g., FIG. 12, the third processing unit 130 performs the preprocessing for the three-dimensional point cloud data, thereby estimating one plane from a plurality of sample points (e.g., 10 points P1 to P10) locally close to each other on the three-dimensional point cloud data. The third processing unit 130 acquires coordinate values [xᵢ, yᵢ, zᵢ] (i = 1 to 10) of the10 sample points P1 to P10 from the three-dimensional point cloud data, and defines one three-dimensional coordinate system Σ₀ in a three-dimensional space. The third processing unit 130 derives four unknown parameters a, b, c, d in a three-dimensional plane ax + by + cz + d = 0 to be estimated such that the sum f = Σdᵢ² of squares of a distance dᵢ from each of the sample points P1 to P10 to the plane is the minimum, thereby estimating the plane. The third processing unit 130 searches a flat surface similar to the estimated plane on the 3D CAD model of the workpiece, and determines a local flat surface with the highest degree of similarity as matched. Note that the third processing unit 130 estimates the plane at the stage of preprocessing the three-dimensional point cloud data, but may approximate a plurality of estimated extremely-small flat surfaces adjacent to each other to one curved surface. The third processing unit 130 may search a curved surface similar to such an approximated curved surface on the 3D CAD model of the workpiece 50, and determine a local curved surface with the highest degree of similarity as matched. Based on the plurality of flat surfaces estimated from the three-dimensional point cloud data and a relative positional relationship thereamong, the plurality of flat and curved surfaces and a relative positional relationship thereamong, or the plurality of curved surfaces and a relative positional relationship thereamong, the third processing unit 130 may perform the matching processing for a plurality of local flat surfaces, local flat and curved surfaces, or local curved surfaces on the 3D CAD model of the workpiece 50, thereby matching the three-dimensional point cloud data and the 3D CAD model of the workpiece 50 with each other.

The third processing unit 130 may extract local features on the three-dimensional point cloud data acquired by the three-dimensional measuring machine 45 as the information acquisition unit, and perform the matching processing between each extracted local feature and the local feature of the 3D CAD model of the workpiece 50 to match the three-dimensional point cloud data and the 3D CAD model of the workpiece 50 with each other.

Specifically, the third processing unit 130 derives the local flat surfaces from the three-dimensional point cloud data acquired by the three-dimensional measuring machine 45 by the above-described method, thereby deriving a plurality of local features of the derived two-dimensional local flat surfaces, such as a hole, a corner, or an edge, by a method similar to the above-described two-dimensional image processing method, for example. Based on the plurality of local features derived as described above and a three-dimensional relative positional relationship thereamong, the third processing unit 130 searches a plurality of local features of the 3D CAD model of the workpiece 50 to be matched. The 3D CAD models of the plurality of workpieces 50 are arranged on the three-dimensional point cloud data such that the positions and postures of the plurality of local features are coincident therebetween, and in this manner, the three-dimensional point cloud data and the 3D CAD models of the workpieces 50 are matched with each other.

The third processing unit 130 may calculate the amount of change in a surface curvature for the three-dimensional point cloud data acquired by the three-dimensional measuring machine 45 as the information acquisition unit and the 3D CAD model of the workpiece 50, thereby performing the matching processing between the three-dimensional point cloud data and the 3D CAD model of the workpiece 50.

Specifically, the third processing unit 130 calculates the amount of change in the surface curvature for the three-dimensional point cloud data acquired by the three-dimensional measuring machine 45 to generate a three-dimensional curvature change map, and calculates the amount of change in the surface curvature for the 3D CAD model of the workpiece 50 to generate a three-dimensional curvature change map, for example. The third processing unit calculates the degree of local similarity between the generated two curvature change maps, performs matching between the curvature change maps at a plurality of local portions with a high degree of similarity exceeding a preset threshold, and performs matching the three-dimensional point cloud data and the 3D CAD model of the workpiece 50 with each other.

Based on a processed result obtained by the third processing unit 130 and the information including at least the pick-up position candidate calculated by the first pick-up candidate calculation unit 113, the fourth pick-up candidate calculation unit 131 may generate at least the pick-up position candidate on the three-dimensional point cloud acquired by the three-dimensional measuring machine 45 as the information acquisition unit.

Specifically, the three-dimensional point cloud data is matched with (arranged on) the 3D CAD model of the workpiece 50, and a more-favorable pick-up position candidate on the three-dimensional point cloud data is calculated from the pick-up position candidate (the three-dimensional relative position on the 3D CAD model of the workpiece 50) calculated by the first pick-up candidate calculation unit 113, for example.

For the overlapping state of the plurality of workpieces 50 on the three-dimensional point cloud data with the pick-up position candidate information, the fourth pick-up candidate calculation unit 131 may delete/adjust a pick-up position candidate for which interference or collision has been sensed by means of an interference checking function or a collision calculation function of the preprocessing unit 111. Alternatively, the preprocessing unit 111 may display, via the display unit 13, the three-dimensional point cloud data with the pick-up position candidate information in a three-dimensional view, the user may visually check the overlapping state of the plurality of workpieces 50 on the three-dimensional point cloud data, and the preprocessing unit 111 may delete/adjust the interference-detected pick-up position candidate covered with other workpieces 50 to reflect such a deletion/adjustment result on the fourth pick-up candidate calculation unit 131.

The third training data generation unit 132 may generate the training data based on the three-dimensional point cloud data acquired by the three-dimensional measuring machine 45 as the information acquisition unit and the information including at least the pick-up position candidate calculated by the fourth pick-up candidate calculation unit 131.

Specifically, the third training data generation unit 132 may numerically generate, for example, a group of plural pieces of three-dimensional position data as the training data by addition of the three-dimensional pick-up position candidate calculated by the fourth pick-up candidate calculation unit 131 to the three-dimensional point cloud data, but may generate the training data in the form of a graph in three-dimensional simulation environment. That is, the third training data generation unit 132 generates, targeting for the plural pieces of three-dimensional point cloud data acquired from the three-dimensional measuring machine 45, the training data (“teacher data”) with the label data which is the plural pieces of three-dimensional point cloud data with the pick-up position candidate data calculated for each of the plural pieces of three-dimensional point cloud data.

### <Training Data Generation Processing of Information Processing Device 10b>

Next, operation relating to training data generation processing of the information processing device 10b according to the third embodiment will be described.

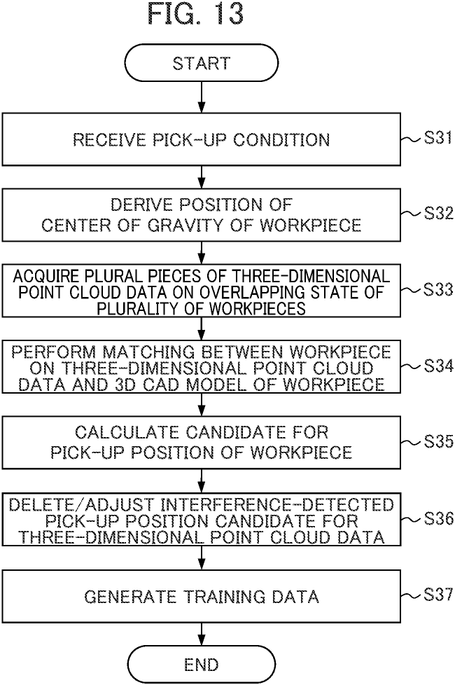

FIG. 13 is a flowchart for describing the training data generation processing of the information processing device 10b. Note that the processing in Steps S31, S32 is similar to that in Steps S11, S12 according to the first embodiment and description thereof will be omitted.

In Step S33, the third processing unit 130 acquires, from the three-dimensional measuring machine 45, the plural pieces of three-dimensional point cloud data on the overlapping state of the plurality of workpieces 50 acquired by the three-dimensional measuring machine 45.

In Step S34, the third processing unit 130 performs the matching processing between each of the plural pieces of three-dimensional point cloud data acquired in Step S33 and the 3D CAD model of the workpiece 50, thereby matching the workpiece 50 on the three-dimensional point cloud and the 3D CAD model of the workpiece 50 with each other.

In Step S35, the fourth pick-up candidate calculation unit 131 calculates, based on the matching relationship between the workpiece 50 on the three-dimensional point cloud derived in Step S34 and the 3D CAD model of the workpiece 50, the candidate for the three-dimensional pick-up position of the workpiece 50 on the three-dimensional point cloud from the three-dimensional pick-up position candidate calculated for the workpiece 50 by the first pick-up candidate calculation unit 113.

In Step S36, the fourth pick-up candidate calculation unit 131 deletes/adjusts, for the overlapping state of the plurality of workpieces 50 on the three-dimensional point cloud data with the pick-up position candidate information, the pick-up position candidate for which the interference or the collision has been sensed by means of the interference checking function or the collusion calculation function of the preprocessing unit 111. Alternatively, the preprocessing unit 111 displays, via the display unit 13, each piece of three-dimensional point cloud data with the pick-up position candidate information in the three-dimensional view, the user visually checks the overlapping state of the plurality of workpieces 50 on the three-dimensional point cloud data, and the preprocessing unit 111 may delete/adjust the interference-detected pick-up position candidate covered with other workpieces 50 to reflect such a deletion/adjustment result on the fourth pick-up candidate calculation unit 131.

In Step S37, the third training data generation unit 132 generates, targeting for the plural pieces of three-dimensional point cloud data acquired in Step S33, the training data (“teacher data”) with the label data which is the plural pieces of three-dimensional point cloud data with the pick-up position candidate data for which no interference with a surrounding obstacle has been detected and which is calculated in step S36.

As described above, the information processing device 10b according to the third embodiment performs the matching processing among the plural pieces of three-dimensional point cloud data on the overlapping state of the plurality of workpieces 50 acquired by the three-dimensional measuring machine 45 and the 3D CAD models of the workpieces 50, thereby matching the workpieces 50 on the three-dimensional point cloud and the 3D CAD models of the workpieces 50 with each other. The information processing device 10b calculates the candidates for the three-dimensional pick-up positions of the workpieces 50 on the three-dimensional point cloud based on the derived matching relationship among the workpieces 50 on the three-dimensional point cloud and the 3D CAD models of the workpieces 50. The information processing device 10b generates, targeting for the plural pieces of three-dimensional point cloud data acquired by the three-dimensional measuring machine 45, the training data (“teacher data”) with the label data which is the plural pieces of three-dimensional point cloud data with the calculated pick-up position candidate data.

With this configuration, the information processing device 10b can easily generate the training data (“teacher data”) necessary for generation of the trained model for specifying the pick-up positions of the workpieces 50 loaded in bulk.

The third embodiment has been described above.

The first embodiment, the second embodiment, and the third embodiment have been described above, but the information processing devices 10, 10a, 10b are not limited to those described above in the embodiments and changes, modifications, etc. may be made without departing from a scope in which the object can be achieved.

### Variation 1

In the first embodiment, the second embodiment, and the third embodiment described above, the information processing devices 10, 10a, 10b have been described as examples of a device different from the robot control device 20, but the robot control device 20 may have some or all of the functions of the information processing device 10, 10a, 10b.

Alternatively, a server may have some or all of the receiving unit 110, the preprocessing unit 111, the first processing unit 112, the first pick-up candidate calculation unit 113, the second pick-up candidate calculation unit 114, the first training data generation unit 115, the training processing unit 116, and the pick-up position selection unit 117 of the information processing device 10, for example. A server may have some or all of the receiving unit 110, the preprocessing unit 111, the second processing unit 120, the first pick-up candidate calculation unit 113, the third pick-up candidate calculation unit 121, the second training data generation unit 122, the training processing unit 116, and the pick-up position selection unit 117 of the information processing device 10a, for example. A server may have some or all of the receiving unit 110, the preprocessing unit 111, the third processing unit 130, the first pick-up candidate calculation unit 113, the fourth pick-up candidate calculation unit 131, the third training data generation unit 132, the training processing unit 116, and the pick-up position selection unit 117 of the information processing device 10b, for example. Each function of the information processing device 10, 10a, 10b may be implemented using, e.g., a virtual server function on the cloud.

The information processing device 10, 10a, 10b may be a distributed processing system in which the functions of the information processing device 10, 10a, 10b are distributed to a plurality of servers as necessary.

### Variation 2

For example, in the first embodiment and the second embodiment described above, the imaging device 40 is, for example, the digital camera that acquires the two-dimensional image, but is not limited to above. For example, the imaging device 40 may be a three-dimensional measuring machine. In this case, the imaging device 40 preferably acquires a distance image or a two-dimensional image such as a gray scale image or an RGB image.

### Variation 3

In the first embodiment, the second embodiment, and the third embodiment described above, the examples where the information for picking up the workpiece 50 by means of the pick-up hand 31 is processed to generate the training data for the machine learning have been described, but the present disclosure is not limited to these examples.

The training data is not necessarily generated. For example, for the two-dimensional images of the overlapping state of the plurality of workpieces 50 acquired by the imaging device 40 as the image acquisition unit, the pick-up position candidate information calculated by the third pick-up candidate calculation unit 121 and the three-dimensional point cloud data acquired by the three-dimensional measuring machine 45 as the information acquisition unit are transmitted to the robot control device 20. The robot control device 20 generates an operation program for the pick-up hand 31, and operates the pick-up hand 31 to pick up the workpiece 50 at a real three-dimensional pick-up position candidate corresponding to the two-dimensional pick-up position candidate on the two-dimensional image. That is, the overlapping state of the plurality of workpieces 50 in a real world is, without generating the training data and depending on the machine learning, imaged in real time, the matching processing between the feature on the captured two-dimensional image and the feature of the 3D CAD model of the workpiece 50 is performed by the second processing unit 120, and the pick-up hand 31 is operated so as to pick up the workpiece 50 at the pick-up position calculated by the third pick-up candidate calculation unit 121 based on the processed result.

Alternatively, the training data is not necessarily generated. For the three-dimensional point cloud data on the overlapping state of the plurality of workpieces 50 acquired by the three-dimensional measuring machine 45 as the information acquisition unit, the pick-up position candidate information calculated by the fourth pick-up candidate calculation unit 131 is transmitted to the robot control device 20. The robot control device 20 generates an operation program for the pick-up hand 31, and operates the pick-up hand 31 to pick up the workpiece 50 at such a pick-up position candidate. That is, the overlapping state of the plurality of workpieces 50 in a real world is, without generating the training data and depending on the machine learning, three-dimensionally measured in real time, the matching processing between the measured three-dimensional point cloud and the 3D CAD model of the workpiece 50 is performed by the third processing unit 130, and the pick-up hand 31 is operated so as to pick up the workpiece 50 at the pick-up position calculated by the fourth pick-up candidate calculation unit 131 based on the processed result.

Note that each function of the information processing device 10, 10a, 10b in one embodiment may be implemented by hardware, software, or a combination thereof. Implementation by the software as described herein means implementation by reading and execution of a program by a computer.

The program can be stored using various types of non-transitory computer readable media and be supplied to the computer. The non-transitory computer readable media include various types of tangible storage media. Examples of the non-transitory computer readable media include magnetic recording media (e.g., a flexible disk, a magnetic tape, and a hard disk drive), magnetic optical recording media (e.g., a magnetic optical disk), a CD-read only memory (CD-ROM), a CD-R, a CD-R/W, and semiconductor memories (e.g., a mask ROM, a programmable ROM (PROM), an erasable PROM (EPROM), a flash ROM, and a RAM). The program may be supplied to the computer via various types of transitory computer readable media. Examples of the transitory computer readable media include an electric signal, an optical signal, and an electromagnetic wave. The transitory computer readable medium can supply the program to the computer via a wired communication path such as an electric wire or an optical fiber or a wireless communication path.

Note that the step of describing the program recorded in the recording medium includes, needless to say, not only processing performed in chronological order but also processing not necessarily performed in chronological order but executed in parallel or individually.

In other words, the information processing device and the information processing method of the present disclosure can be implemented as various embodiments having the following configurations.

(1) The information processing device 10 of the present disclosure is an information processing device for processing information for picking up a workpiece 50 by means of a pick-up hand 31 of a robot 30, the information processing device including a receiving unit 110 configured to receive a pick-up condition including information on the pick-up hand 31 or the workpiece 50, a preprocessing unit 111 configured to derive at least the position of the center of gravity of the workpiece 50 based on a 3D CAD model of the workpiece 50, and a first processing unit 112 configured to derive a local feature of the 3D CAD model of the workpiece according to the pick-up condition based on the derived position of the center of gravity of the workpiece 50.

According to the information processing device 10, training data (“teacher data”) necessary for generation of a trained model for specifying the pick-up positions of the workpieces loaded in bulk can be easily generated.

(2) In the information processing device 10 according to (1), the receiving unit 110 may receive the pick-up condition including at least one of information on the shape and size of a portion of the pick-up hand 31 contacting the workpiece 50, information on a movable range of the pick-up hand 31, distribution information on the material, or density, or friction coefficient of the workpiece 50, or a part of pick-up availability information, and the first processing unit 112 may derive the local feature according to the pick-up condition received by the receiving unit 110.

With this configuration, the information processing device 10 can derive an optimal local feature matched with the pick-up hand 31 or the workpiece 50 in the pick-up condition.

(3) The information processing device 10 according to (1) or (2) further includes a first pick-up candidate calculation unit 113 configured to automatically calculate at least one candidate of the pick-up position of the workpiece 50 based on the derived local feature.

With this configuration, according to the information processing device 10, the pick-up hand 31 can smoothly contact the workpiece 50 with favorable fitting of a surface of a suction pad or surfaces of a pair of gripping fingers contacting the workpiece 50 while air leakage and shift of the position of the workpiece 50 by the pick-up hand 31 when the pick-up hand 31 picks up the workpiece 50 at the pick-up position candidate are prevented. The pick-up hand 31 can contact and pick up the workpiece 50 at a position close to the center of gravity of the workpiece, rotary motion about the center of gravity of the workpiece upon lifting can be prevented, and the pick-up hand 31 can stably pick up the workpiece 50 without collision with a surrounding obstacle such as a workpiece 50 or a wall of a container 60.

(4) In the information processing device 10 according to (3), the first pick-up candidate calculation unit 113 may automatically calculate a candidate of the pick-up posture of the workpiece based on the derived local feature.

With this configuration, according to the information processing device 10, dropping of the workpiece 50 caused by rotary motion about the center of gravity of the workpiece 50 upon lifting thereof due to contact of the pick-up hand 31 with the workpiece 50 at an unintended position can be prevented, and the pick-up hand 31 can stably pick up the workpiece 50.

(5) In the information processing device 10 according to (3) or (4), the first pick-up candidate calculation unit 113 may correct, by using an interference checking function or a collision calculation function of the preprocessing unit 111, a pick-up position candidate and/or the pick-up posture candidate calculated by the first pick-up candidate calculation unit 113.

With this configuration, according to the information processing device 10, the pick-up hand 31 can more reliably pick up the target workpiece 50 without collision with a surrounding obstacle such as other workpieces 50 or a container wall upon pick-up.

(6) The information processing device 10 according to any one of (3) to (5) may further include a second pick-up candidate calculation unit 114. The preprocessing unit 111 may randomly generate at least an overlapping state of a plurality of workpieces 50 by using the 3D CAD model of the workpiece, and the second pick-up candidate calculation unit 114 may automatically generate, based at least on a pick-up position candidate calculated by the first pick-up candidate calculation unit 113, at least a pick-up position of the plurality of workpieces 50 in the overlapping state.

With this configuration, the information processing device 10 can calculate more-favorable pick-up positions of the plurality of workpieces 50 without the interference with a surrounding obstacle in the overlapping state of the plurality of workpieces 50.

(7) In the information processing device 10 according to (6), the second pick-up candidate calculation unit 114 may correct, by using an interference checking function or a collision calculation function of the preprocessing unit 111, at least a pick-up position of the plurality of workpieces 50 generated by the second pick-up candidate calculation unit 114.

With this configuration, according to the information processing device 10, the pick-up hand 31 can more reliably pick up the workpiece 50 even in the overlapping state of the plurality of workpieces 50.

(8) The information processing device 10 according to (6) or (7) may further include a first training data generation unit 115 configured to generate training data based on a two-dimensional projection image projected from the overlapping state of the plurality of workpieces 50 generated by the preprocessing unit 111 and information including at least a pick-up position of the plurality of workpieces generated by the second pick-up candidate calculation unit 114.

With this configuration, the information processing device 10 can produce an advantageous effect similar to that of (1).

(9) The information processing device 10a according to (3) to (5) may further include an imaging device 40 configured to acquire a plurality of images of a region where the workpiece 50 is present, and a second processing unit 120 configured to perform matching processing between a feature extracted by image processing for each of the plurality of images and the derived local feature of the 3D CAD model of the workpiece 50.

With this configuration, the information processing device 10a can associate each feature on the plurality of two-dimensional images and the feature of the 3D CAD model of the workpiece 50 with each other, and can associate each workpiece 50 on the plurality of two-dimensional images and the 3D CAD model of the workpiece 50 with each other.

(10) The information processing device 10a according to (9) may further include a third pick-up candidate calculation unit 121. The third pick-up candidate calculation unit 121 may automatically generate, based on a processed result obtained by the second processing unit 120 and at least a pick-up position candidate calculated by the first pick-up candidate calculation unit 113, at least the pick-up position of the workpiece 50 on the plurality of images acquired by the imaging device 40.

With this configuration, the information processing device 10a can produce an advantageous effect similar to that of (6).

(11) In the information processing device 10a according to (10), the preprocessing unit 111 may generate an overlapping state of a plurality of workpieces 50 corresponding to the plurality of two-dimensional images based on the processed result obtained by the second processing unit 120. The third pick-up candidate calculation unit 121 may correct, by using an interference checking function or a collision calculation function of the preprocessing unit 111, at least a pick-up position of the plurality of workpieces 50 generated by the third pick-up candidate calculation unit 121.

With this configuration, the information processing device 10a can produce an advantageous effect similar to that of (7).

(12) The information processing device 10a according to (10) or (11) may further include a second training data generation unit 122 configured to generate training data based on the plurality of two-dimensional images acquired by the imaging device 40 and information including at least a candidate for the pick-up position generated by the third pick-up candidate calculation unit 121.

With this configuration, the information processing device 10a can produce an advantageous effect similar to that of (1).

(13) The information processing device 10b according to any one of (3) to (5) may further include a three-dimensional measuring machine 45 configured to acquire plural pieces of three-dimensional point cloud data on a region where the workpiece 50 is present, and a third processing unit 130 configured to perform matching processing between each of the plural pieces of three-dimensional point cloud data and the 3D CAD model of the workpiece 50.

With this configuration, the information processing device 10b can associate a feature of each of the plural pieces of three-dimensional point cloud data and the 3D CAD model of the workpiece 50 with each other, and can associate each of the plural pieces of three-dimensional point cloud data and the 3D CAD model of the workpiece 50 with each other.

(14) The information processing device 10b according to (13) may further include a fourth pick-up candidate calculation unit 131. The fourth pick-up candidate calculation unit 131 may automatically generate, based on a processed result obtained by the third processing unit 130 and at least a pick-up position candidate calculated by the first pick-up candidate calculation unit 113, at least the pick-up position of the workpiece 50 on the plural pieces of three-dimensional point cloud data acquired by the three-dimensional measuring machine 45.

With this configuration, the information processing device 10b can produce an advantageous effect similar to that of (6).

(15) In the information processing device 10b according to (14), the fourth pick-up candidate calculation unit 131 may correct, based on the three-dimensional point cloud data acquired by the three-dimensional measuring machine 45, at least a pick-up position of a plurality of workpieces 50 generated by the fourth pick-up candidate calculation unit 131 by using an interference checking function or a collision calculation function of the preprocessing unit 111.

With this configuration, the information processing device 10b can produce an advantageous effect similar to that of (7).

(16) The information processing device 10b according to (14) or (15) may further include a third training data generation unit 132 configured to generate training data based on the three-dimensional point cloud data acquired by the three-dimensional measuring machine 45 and information including at least a candidate for the pick-up position generated by the fourth pick-up candidate calculation unit 131.

With this configuration, the information processing device 10b can produce an advantageous effect similar to that of (1).

(17) The information processing method of the present disclosure is an information processing method for implementation by a computer for processing information for picking up a workpiece 50 by means of a pick-up hand 31 of a robot 30, the information processing method including a receiving step of receiving a pick-up condition including information on the pick-up hand 31 or the workpiece 50, a preprocessing step of deriving at least the position of the center of gravity of the workpiece 50 based on a 3D CAD model of the workpiece 50, and a first processing step of deriving a local feature of the 3D CAD model of the workpiece 50 according to the pick-up condition based on the derived position of the center of gravity of the workpiece.

According to the information processing method, an advantageous effect similar to that of (1) can be produced.

EXPLANATION OF REFERENCE NUMERALS

| 1, 1A | Robot System |
|---|---|
| 10, 10a, 10b | Information Processing Device |
| 11 | Control Unit |
| 110 | Receiving Unit |
| 111 | Preprocessing Unit |
| 112 | First Processing Unit |
| 113 | First Pick-Up Candidate Calculation Unit |
| 114 | Second Pick-Up Candidate Calculation Unit |
| 115 | First Training Data Generation Unit |
| 120 | Second Processing Unit |
| 121 | Third Pick-Up Candidate Calculation Unit |
| 122 | Second Training Data Generation Unit |
| 130 | Third Processing Unit |
| 131 | Fourth Pick-Up Candidate Calculation Unit |
| 132 | Third Training Data Generation Unit |
| 12 | Input Unit |
| 13 | Display Unit |
| 14 | Storage Unit |
| 20 | Robot Control Device |
| 30 | Robot |
| 31 | Pick-Up Hand |
| 40 | Imaging Device |
| 45 | Three-Dimensional Measuring Machine |
| 50 | Workpiece |
| 60 | Container |

1. An information processing device for processing information for picking up a workpiece by means of a hand, comprising:
a receiving unit configured to receive a pick-up condition including information on the hand or the workpiece;
a preprocessing unit configured to derive at least a position of a center of gravity of the workpiece based on a 3D CAD model of the workpiece; and
a first processing unit configured to derive a local feature of the 3D CAD model of the workpiece according to the pick-up condition based on the derived position of the center of gravity of the workpiece.

2. The information processing device according to claim 1, wherein
the receiving unit receives the pick-up condition including at least one of information on a shape and a size of a portion of the hand contacting the workpiece, information on a movable range of the hand, distribution information on a material, or a density, or a friction coefficient of the workpiece, or a part of pick-up availability information, and
the first processing unit derives the local feature according to the pick-up condition received by the receiving unit.

3. The information processing device according to claim 1, further comprising:
a first pick-up candidate calculation unit configured to automatically calculate at least one candidate of a pick-up position of the workpiece based on the derived local feature.

4. The information processing device according to claim 3, wherein
the first pick-up candidate calculation unit automatically calculates a candidate of a pick-up posture of the workpiece based on the derived local feature.

5. The information processing device according to claim 3, wherein
the first pick-up candidate calculation unit corrects, by using an interference checking function or a collision calculation function of the preprocessing unit, a pick-up position candidate and/or the pick-up posture candidate calculated by the first pick-up candidate calculation unit.

6. The information processing device according to claim 3, further comprising:
a second pick-up candidate calculation unit, wherein
the preprocessing unit randomly generates at least an overlapping state of a plurality of workpieces by using the 3D CAD model of the workpiece, and
the second pick-up candidate calculation unit automatically generates, based at least on a pick-up position candidate calculated by the first pick-up candidate calculation unit, at least a pick-up position of the plurality of workpieces in the overlapping state.

7. The information processing device according to claim 6, wherein the second pick-up candidate calculation unit corrects, by using an interference checking function or a collision calculation function of the preprocessing unit, at least a pick-up position of the plurality of workpieces generated by the second pick-up candidate calculation unit.

8. The information processing device according to claim 6, further comprising:
a first training data generation unit configured to generate training data based on a two-dimensional projection image projected from the overlapping state of the plurality of workpieces generated by the preprocessing unit and information including at least a pick-up position of the plurality of workpieces generated by the second pick-up candidate calculation unit.

9. The information processing device according to claim 3, further comprising:
an information acquisition unit configured to acquire a plurality of images of a region where the workpiece is present; and
a second processing unit configured to perform matching processing between a feature extracted by image processing for each of the plurality of images and the derived local feature of the 3D CAD model of the workpiece.

10. The information processing device according to claim 9, further comprising:
a third pick-up candidate calculation unit, wherein
the third pick-up candidate calculation unit automatically generates, based on a processed result obtained by the second processing unit and at least a pick-up position candidate calculated by the first pick-up candidate calculation unit, at least a pick-up position of the workpiece on the images acquired by the information acquisition unit.

11. The information processing device according to claim 10, wherein
the preprocessing unit generates an overlapping state of a plurality of workpieces corresponding to the images based on the processed result obtained by the second processing unit, and
the third pick-up candidate calculation unit corrects, by using an interference checking function or a collision calculation function of the preprocessing unit, at least a pick-up position of the plurality of workpieces generated by the third pick-up candidate calculation unit.

12. The information processing device according to claim 10, further comprising:
a second training data generation unit configured to generate training data based on the images acquired by the image acquisition unit and information including at least a candidate for the pick-up position generated by the third pick-up candidate calculation unit.

13. The information processing device according to claim 3, further comprising:
an information acquisition unit configured to acquire plural pieces of three-dimensional point cloud data on a region where the workpiece is present; and
a third processing unit configured to perform matching processing between each of the plural pieces of three-dimensional point cloud data and the 3D CAD model of the workpiece.

14. The information processing device according to claim 13, further comprising:
a fourth pick-up candidate calculation unit,
wherein the fourth pick-up candidate calculation unit automatically generates, based on a processed result obtained by the third processing unit and at least a pick-up position candidate calculated by the first pick-up candidate calculation unit, at least a pick-up position of the workpiece on the three-dimensional point cloud data acquired by the information acquisition unit.

15. The information processing device according to claim 14, wherein
the fourth pick-up candidate calculation unit corrects, based on the three-dimensional point cloud data, at least a pick-up position of a plurality of workpieces generated by the fourth pick-up candidate calculation unit by using an interference checking function or a collision calculation function of the preprocessing unit.

16. The information processing device according to claim 14, further comprising:
a third training data generation unit configured to generate training data based on the three-dimensional point cloud data acquired by the information acquisition unit and information including at least a candidate for the pick-up position generated by the fourth pick-up candidate calculation unit.

17. An information processing method for implementation by a computer for processing information for picking up a workpiece by means of a hand, comprising:
a receiving step of receiving a pick-up condition including information on the hand or the workpiece;
a preprocessing step of deriving at least a position of a center of gravity of the workpiece based on a 3D CAD model of the workpiece; and
a first processing step of deriving a local feature of the 3D CAD model of the workpiece according to the pick-up condition based on the derived position of the center of gravity of the workpiece.
